(19) United States
(12) Patent Application Publication
(10) Pub. No.: US 2026/0089726 A1
(43) Pub. Date: Mar. 26, 2026

(54) PRECODER GRANULARITIES FOR DM-RS BASED PDCCH PRUNING

(71) Applicant: QUALCOMM Incorporated, San Diego, CA (US)

(72) Inventors: Weimin DUAN, San Diego, CA (US); Gabi SARKIS, San Diego, CA (US); Kangqi LIU, San Diego, CA (US)

(21) Appl. No.: 18/892,064

(22) Filed: Sep. 20, 2024

(51) Int. Cl. H04W 72/23; H04B 7/0456

(52) U.S. Cl. CPC H04W 72/23; H04B 7/0456

(57) ABSTRACT

Precoder granularities for DM-RS based PDCCH pruning are described. An apparatus is configured to receive, from a network node, at least one CORESET that includes a first precoder granularity associated with a first CORESET symbol and a second precoder granularity associated with a second CORESET symbol. The second precoder granularity is different than the first precoder granularity. The apparatus is configured to identify a presence or an absence of a PDCCH candidate in the at least one CORESET based on an associated presence or an associated absence of a DM-RS for the first CORESET symbol. The apparatus is configured to decode or refrain from decoding the first CORESET symbol and the second CORESET symbol based on the presence or the absence of the PDCCH candidate in the at least one CORESET.

### TECHNICAL FIELD

The present disclosure relates generally to communication systems, and more particularly, to wireless communications utilizing precoders.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a user equipment (UE). The apparatus is configured to receive, from a network node, at least one control resource set (CORESET) that includes a first precoder granularity associated with a first CORESET symbol and a second precoder granularity associated with a second CORESET symbol, where the second precoder granularity is different than the first precoder granularity. The apparatus is configured to identify a presence or an absence of a physical downlink control channel (PDCCH) candidate in the at least one CORESET based on an associated presence or an associated absence of a demodulation reference signal (DM-RS) for the first CORESET symbol. The apparatus is configured to decode or refrain from decoding the first CORESET symbol and the second CORESET symbol based on the presence or the absence of the PDCCH candidate in the at least one CORESET.

In the aspect, the method includes receiving, from a network node, at least one CORESET that includes a first precoder granularity associated with a first CORESET symbol and a second precoder granularity associated with a second CORESET symbol, where the second precoder granularity is different than the first precoder granularity. The method includes identifying a presence or an absence of a PDCCH candidate in the at least one CORESET based on an associated presence or an associated absence of a DM-RS for the first CORESET symbol. The method includes decoding or refraining from decoding the first CORESET symbol and the second CORESET symbol based on the presence or the absence of the PDCCH candidate in the at least one CORESET.

In an aspect of the disclosure, a method, a computer-readable medium, and an apparatus are provided. The apparatus is configured to configure a UE with a precoder granularity configuration indicative of a set of precoder granularities for at least one CORESET, where the set of precoder granularities includes a first precoder granularity associated with a first CORESET symbol of the at least one CORESET and a second precoder granularity associated with a second CORESET symbol of the at least one CORESET, where the second precoder granularity is different than the first precoder granularity. The apparatus is configured to transmit, for the UE, the at least one CORESET that includes the first precoder granularity associated with the first CORESET symbol and the second precoder granularity associated with the second CORESET symbol.

In the aspect, the method includes configuring a UE with a precoder granularity configuration indicative of a set of precoder granularities for at least one CORESET, where the set of precoder granularities includes a first precoder granularity associated with a first CORESET symbol of the at least one CORESET and a second precoder granularity associated with a second CORESET symbol of the at least one CORESET, where the second precoder granularity is different than the first precoder granularity. The method includes transmitting, for the UE, the at least one CORESET that includes the first precoder granularity associated with the first CORESET symbol and the second precoder granularity associated with the second CORESET symbol.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of precoder granularities for a CORESET.

FIG. 5 is a call flow diagram for wireless communications, in accordance with various aspects of the present disclosure.

FIG. 6 is a diagram illustrating an example of precoder granularities for DM-RS based PDCCH pruning, in accordance with various aspects of the present disclosure.

FIG. 7 is a diagram illustrating an example of precoder granularities for DM-RS based PDCCH pruning, in accordance with various aspects of the present disclosure.

FIG. 8 is a diagram illustrating an example of precoder granularities for DM-RS based PDCCH pruning, in accordance with various aspects of the present disclosure.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

Wireless communication networks may be designed to support communications between network nodes (e.g., base stations, gNBs, etc.)/network entities (e.g., in a core network) and UEs. In some examples of such communications, DM-RS precoding may utilize a sameAsREG-bundle configuration (e.g., the precoding on associated PDCCH transmissions is the same within a resource element (RE) group (REG) bundle, and the PDCCH DM-RS transmission is across the physical resource blocks (PRBs) associated with the PDCCH) or an allContiguousRBs configuration (e.g., the precoding is the same across all REGs within the set of contiguous resource blocks (RBs) in the CORESET, and the PDCCH DM-RS transmission is across the entire CORESET region). Currently, a DM-RS is mapped on all REGs on all the OFDM symbols of a given PDCCH candidate, the DM-RS density is the same on all REGs, and the DM-RS positions are evenly-distributed within a REG. A UE in LTE/5G NR performs multiple decoding attempts (e.g., up to 44 per slot for a NR UE) to check if downlink control information (DCI) is present or not, and in such cases, PDCCH blind detection may be a major source of UE power consumption. Some current solutions provide for early termination of PDCCH monitoring in order to conserve power.

However, when the CORESET is configured with a wide-band (WB) precoder granularity (e.g., allContiguousRBs), the DM-RS is mapped to all the REGs, and therefore, the DM-RS detection may not confirm whether there is a PDCCH for a specific UE, or which PDCCH candidate is transmitted. That is, in such cases, early detection of a control channel for a UE may not be possible based on current DM-RS configurations, and a UE may not be enabled to conserve power that is utilized to detect its PDCCH.

Various aspects relate generally to wireless communications utilizing precoders. Some aspects more specifically relate to precoder granularities for DM-RS based PDCCH pruning. In some examples, a UE may receive a CORESET(s) that includes a first precoder granularity associated with a first CORESET symbol and a second precoder granularity associated with a second CORESET symbol that is different than the first precoder granularity. The UE may identify a presence or an absence of a PDCCH candidate in the CORESET(s) based on an associated presence or an associated absence of a DM-RS for the first CORESET symbol, and respectively decode or refrain from decoding the first CORESET symbol and the second CORESET symbol based on the presence or the absence of the PDCCH candidate in the CORESET(s).

Particular aspects of the subject matter described in this disclosure can be implemented to realize one or more of the following potential advantages. In some examples, by improving DM-RS configurations, the described techniques can be used to enable PDCCH pruning/absence detection based on the DM-RS. In some examples, by improving the DM-RS configurations, the described techniques can be used to enable an earlier PDCCH absence detection based on the DM-RS and increase power savings. In some examples, by improving PDCCH pruning based on the DM-RS configurations, the described techniques can be used to enable a reduction in PDCCH blind decoding hardware footprint.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

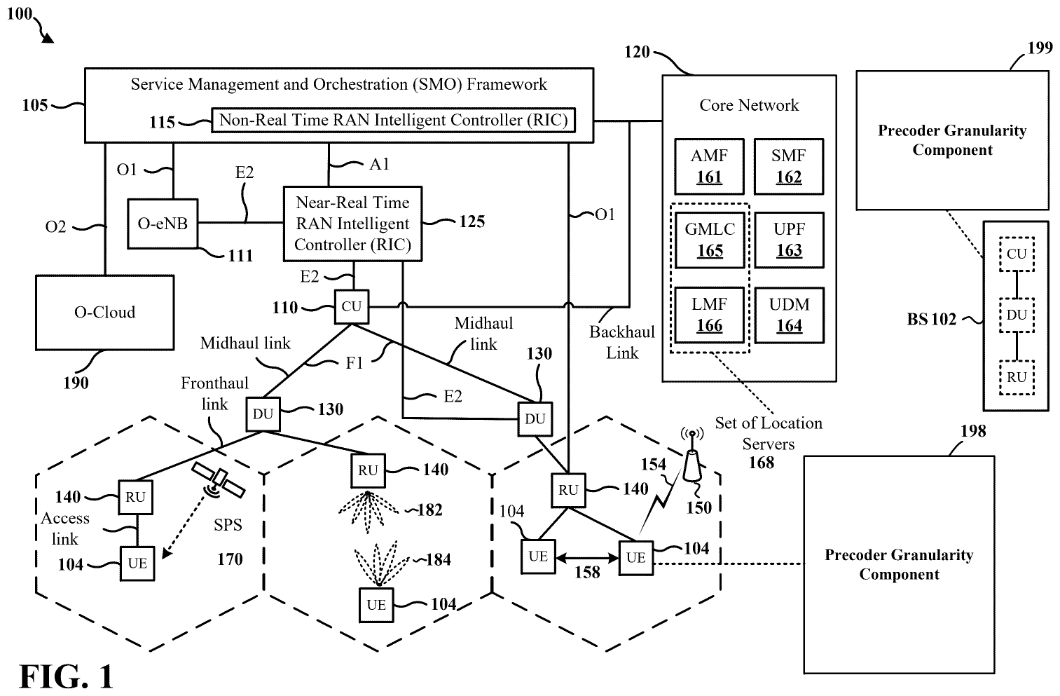

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a precoder granularity component 198 (“component 198”) that may be configured to receive, from a network node, at least one CORESET that includes a first precoder granularity associated with a first CORESET symbol and a second precoder granularity associated with a second CORESET symbol, where the second precoder granularity is different than the first precoder granularity. The component 198 may be configured to identify a presence or an absence of a PDCCH candidate in the at least one CORESET based on an associated presence or an associated absence of a DM-RS for the first CORESET symbol. The component 198 may be configured to decode or refrain from decoding the first CORESET symbol and the second CORESET symbol based on the presence or the absence of the PDCCH candidate in the at least one CORESET. The component 198 may be configured to receive, from the network node, a precoder granularity configuration indicative of a set of precoder granularities, where the set of precoder granularities includes the first precoder granularity and the second precoder granularity. The component 198 may be configured to estimate a joint channel across the first CORESET symbol and the second CORESET symbol based on the DM-RS being non-transparent. In certain aspects, the base station 102 may have a precoder granularity component 199 (“component 199”) that may be configured to configure a UE with a precoder granularity configuration indicative of a set of precoder granularities for at least one CORESET, where the set of precoder granularities includes a first precoder granularity associated with a first CORESET symbol of the at least one CORESET and a second precoder granularity associated with a second CORESET symbol of the at least one CORESET, where the second precoder granularity is different than the first precoder granularity. The component 199 may be configured to transmit, for the UE, the at least one CORESET that includes the first precoder granularity associated with the first CORESET symbol and the second precoder granularity associated with the second CORESET symbol. Accordingly, aspects provide for precoder granularities for DM-RS based PDCCH pruning. Aspects may enable PDCCH pruning/absence detection based on improved DM-RS configurations, may enable an earlier PDCCH absence detection based on the improved DM-RS configurations and increase power savings, and may enable a reduction in PDCCH blind decoding hardware footprint by improving PDCCH pruning based on the DM-RS configurations.

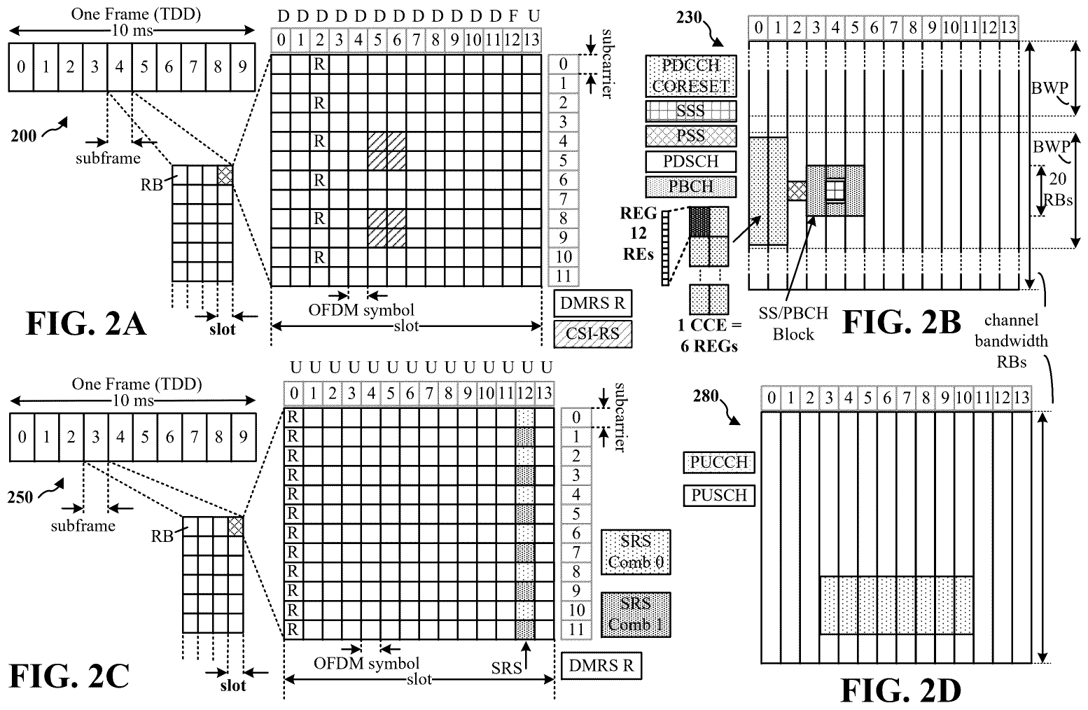

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

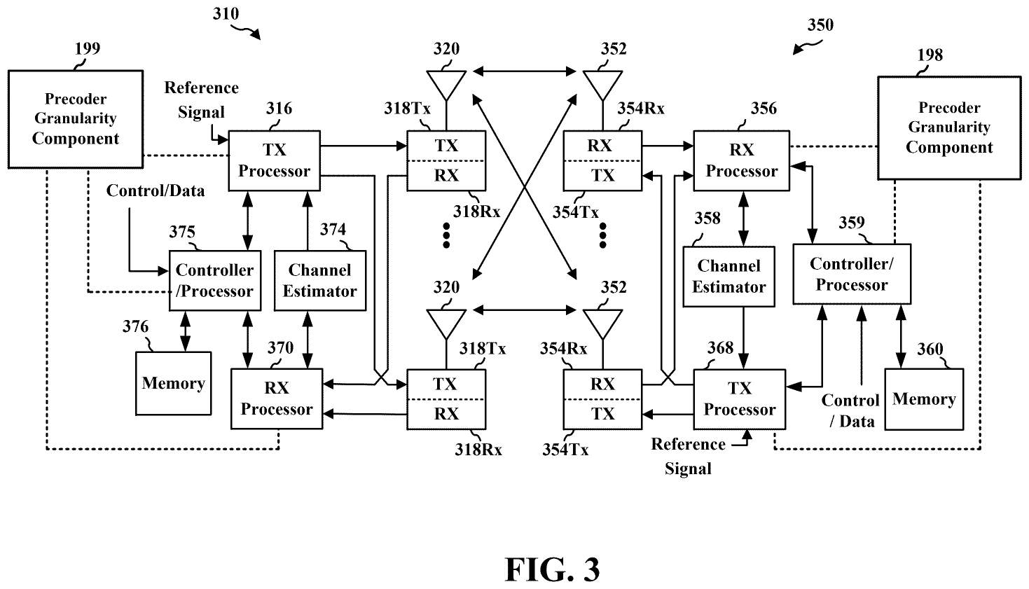

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

DM-RS precoding may utilize a sameAsREG-bundle configuration (e.g., the precoding on associated PDCCH transmissions is the same within a resource element REG bundle, and the PDCCH DM-RS transmission is across the PRBs associated with the PDCCH) or an allContiguousRBs configuration (e.g., the precoding is the same across all REGs within the set of contiguous RBs in the CORESET, and the PDCCH DM-RS transmission is across the entire CORESET region). Currently, a DM-RS is mapped on all REGs on all the OFDM symbols of a given PDCCH candidate, the DM-RS density is the same on all REGs, and the DM-RS positions are evenly-distributed within a REG. A UE in LTE/5G NR performs multiple decoding attempts (e.g., up to 44 per slot for a NR UE) to check if DCI is present or not, and in such cases, PDCCH blind detection may be a major source of UE power consumption. Some current solutions provide for early termination of PDCCH monitoring in order to conserve power. However, when the CORESET is configured with a WB precoder granularity (e.g., allContiguousRBs), the DM-RS is mapped to all the REGs, and therefore, the DM-RS detection may not confirm whether there is a PDCCH for a specific UE, or which PDCCH candidate is transmitted. That is, in such cases, early detection of a control channel for a UE may not be possible based on current DM-RS configurations, and a UE may not be enabled to conserve power that is utilized to detect its PDCCH.

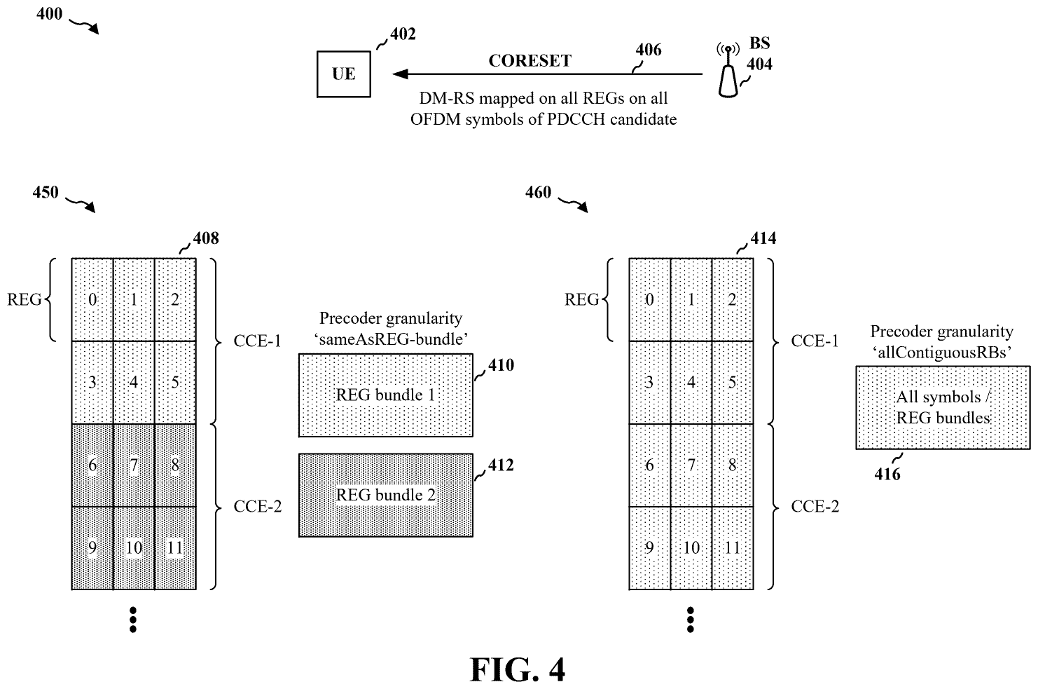

FIG. 4 is a diagram 400 illustrating an example of precoder granularities for a CORESET. Generally, a DM-RS density per REG is 1-to-4 (or one fourth) for a normal CP (NCP) and an extended CP (ECP), and the DM-RS REs are the first, the fifth, and the ninth REs. A configurable identifier (ID) for a PDCCH DM-RS may be used at least for the initialization of DM-RS sequence/scrambling. As one example, for each CORESET configured by the PBCH, a physical cell ID may be used for DM-RS sequence initialization. As another example, for each CORESET configured by a remaining minimum SIBI (RMSI), the PDCCH DM-RS may be configured with a configurable ID for DM-RS sequence initialization via the RMSI, and if not configured, a physical cell ID may be used for DM-RS sequence initialization. In such cases, the value range of the configurable ID may be the same as that for the physical cell ID (e.g., 10 bits). As another example, for each CORESET configured by UE-specific RRC signaling, a UE may be configured with a configurable ID, N_{ID}⁽ⁿ^{_{SCID}}⁾, for DM-RS sequence initialization, where N_{ID}⁽ⁿ^{_{SCID}}⁾ is a 16-bit scrambling ID with a default value of physical cell ID and six known bits (e.g., ‘000000’). In some configurations, the DM-RS and PDCCH (e.g., after coding) may be scrambled by the same length-31 Gold sequence as in LTE. For instance, the DM-RS sequence for the PDCCH may be obtained according to a reference point in frequency domain: PRB 0 of common PRB indexing for a UE-specific CORESET, and/or PRB 0 of the initial active DL BWP for CORESET configured by the PBCH/RMSI.

Diagram 400 shows a UE 402 that receives a CORESET 406 from a network node (e.g., a base station 404, a gNB, and/or the like). The associated DM-RS for symbols of the CORESET 406 is mapped to all REGs on all OFDM symbols of PDCCH candidates.

In a configuration 450 of the diagram 400, a CORESET 408 may utilize a precoder granularity that is the same for each REG bundle (e.g., a sameAsREG-bundle configuration), as shown. As an example, a precoder granularity 410 may be used for a first REG bundle or control channel element (CCE) (e.g., a CCE-1) of the CORESET 408, while a precoder granularity 412 (e.g., a different precoder granularity) may be used for a second REG bundle or CCE (e.g., a CCE-2) of the CORESET 408, etc.

In a configuration 460 of the diagram 400, a CORESET 414 may utilize a precoder granularity that is the same for all symbols/REG bundles (e.g., an allContiguousRBs configuration) of the CORESET 414, as shown. As an example, a precoder granularity 416 may be used for all REG bundles/CCEs (e.g., CCE-1, CCE-2, etc.) of the CORESET 414.

Aspects herein provide for precoder granularity enhancements to improve DM-RS-detection-based PDCCH pruning. The main proposal is to use a mixture of different DM-RS precoding granularities over the CORESET symbols. For example, the first symbol in the CORESET uses REG-bundle-level precoding, while the rest of the symbols use wideband precoding. In this way, the DM-RS detection is performed in the first symbol of the CORESET. For the joint channel estimation across multiple CORESET symbols, non-transparent codebook-based precoding for the first symbol is also proposed. The second main proposal is to use paired CORESETs, where the first CORESET uses REG-bundle-level precoding and the second CORESET uses wide-band precoding. Aspects herein provide precoder granularities for DM-RS based PDCCH pruning enable PDCCH pruning/absence detection based on improved DM-RS configurations. Aspects enable an earlier PDCCH absence detection based on the improved DM-RS configurations and increase power savings. Aspects also enable a reduction in PDCCH blind decoding hardware footprint by improving PDCCH pruning based on the DM-RS configurations. In aspects, configuration/indication for DM-RS may be on a per CORESET basis, and may provide for PDCCH monitoring early termination based DM-RS detection for UE power savings. For example, as DM-RS processing is one of the first DL processing steps in control channel detection, the control channel absence may be determined early in the processing pipeline, allowing the saving of cycles for de-mapping, decoding, post channel estimation, and/or the like. In other words, the earlier the absence of the control channel is detected, the higher the power saving opportunity becomes, and accordingly, it may be desirable to detect the absence of PDCCH as early as possible. Aspects enable an earlier detection, as described herein. Moreover, the DM-RS based PDCCH pruning described for aspects herein may reduce the number of blind decoding instances utilized for a candidate PDCCH, which may further reduce the area of the PDCCH processing hardware.

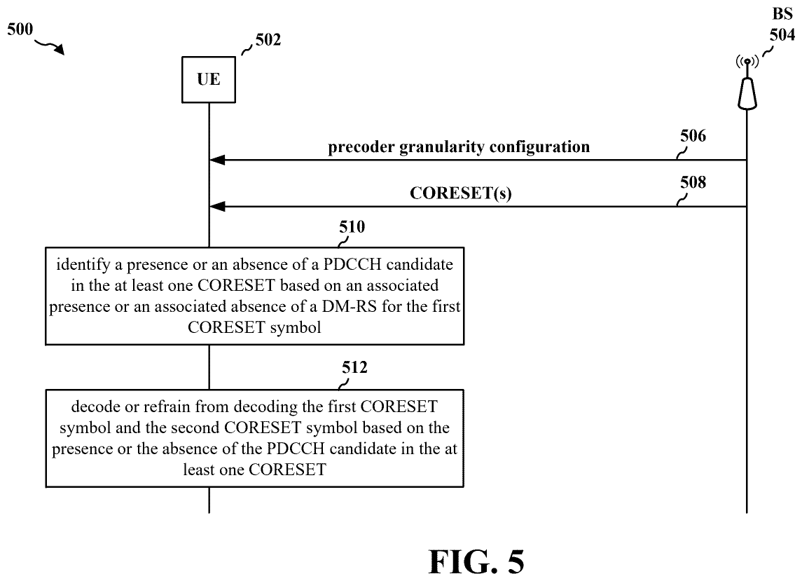

FIG. 5 is a call flow diagram 500 for wireless communications, in various aspects. Call flow diagram 500 illustrates precoder granularities for DM-RS based PDCCH pruning for a UE (e.g., a UE 502), by way of example, that communicates with a network node (e.g., a base station 504, a gNB, etc., as shown and described herein), by way of example. While call flow diagram 500 is illustrated and described with respect to a base station, aspects include that the base station 504 may be two or more base stations. Aspects described for base stations, and for network nodes/entities herein, generally, may be performed in aggregated form and/or by one or more components in disaggregated form. Additionally, or alternatively, the aspects may be performed by a UE autonomously, in addition to, and/or in lieu of, operations of a network node/base station.

In the illustrated aspect, the UE 502 may be configured to receive, and the base station 504 may be configured to transmit/provide/configure, a precoder granularity configuration 506. The precoder granularity configuration 506 may be indicative of a set of precoder granularities that includes at least a first precoder granularity and a second precoder granularity for a CORESET(s) (e.g., at least one CORESET 508). In other words, the base station 504 may configure the UE 502 with the precoder granularity configuration 506 that is indicative of a set of precoder granularities for the at least one CORESET 508. In aspects, the set of precoder granularities 710 may include a first precoder granularity associated with a first CORESET symbol of the at least one CORESET 508 and a second precoder granularity associated with a second CORESET symbol of the at least one CORESET 508, and the second precoder granularity may be different than the first precoder granularity. In aspects, the first precoder granularity associated with the first CORESET symbol may be equal to a first number of REGs in a frequency domain (FD) for a narrow band (NB) REG bundle within a CCE associated with the at least one CORESET 508. In some aspects, a CCE-to-REG mapping may be non-interleaved and the first precoder granularity associated with the first CORESET symbol may be associated with a second number of REGs in each CCE, an aggregation level, and a third number of CORESET symbols in the at least one CORESET 508. In aspects, the second precoder granularity may be a WB precoder granularity (e.g., for a WB REG bundle) and the first precoder granularity may be a smaller precoder granularity than the WB precoder granularity.

The UE 502 may be configured to receive, from a network node (e.g., the base station 504, which may be configured to transmit/provide), the at least one CORESET 508 that may include the first precoder granularity associated with a first CORESET symbol and the second precoder granularity associated with a second CORESET symbol of the at least one CORESET 508. In aspects, the first CORESET symbol may include a one-to-one mapping between the DM-RS and the PDCCH candidate. In some aspects, the first CORESET symbol and the second CORESET symbol are of a same CORESET of the at least one CORESET 508. The first precoder granularity may be associated with a first symbol index of the first CORESET symbol and the second precoder granularity may be associated with a second symbol index of the second CORESET symbol. In aspects, the first symbol index may be different than the second symbol index.

In some aspects, the first CORESET symbol and the second CORESET symbol may be of different CORESETs of the at least one CORESET 508. For example, the different CORESETs may include a first CORESET and a second CORESET, and the first CORESET symbol and the second CORESET symbol may include a search space mapping to a same search space set. In such aspects, the PDCCH candidate may be a single PDCCH that is associated with each CORESET of the at least one CORESET 508. The first CORESET may be configured with a higher DM-RS density than other CORESETs of the at least one CORESET, in various configurations. In some aspects, the first CORESET may be configured at a beginning of the at least one CORESET 508 (e.g., may be an initial CORESET provided for the at least one CORESET 508). In some aspects, the first precoder granularity may be different than a WB precoder granularity (e.g., for a WB REG bundle) and may be associated with the first CORESET, and the first precoder granularity may be equal to a first number of REGs in a frequency domain for a narrow band REG bundle within a CCE associated with the first CORESET. In some aspects, a CCE-to-REG mapping may be non-interleaved and the first precoder granularity associated with the first CORESET may be associated with a second number of REGs in each CCE, an aggregation level, and a third number of CORESET symbols in the first CORESET of the at least one CORESET 508.

The UE 502 may be configured to identify (at 510) a presence or an absence of a PDCCH candidate in the at least one CORESET 508 based on an associated presence or an associated absence of a DM-RS for the first CORESET symbol. In aspects, to identify (at 510) the presence or the absence of the PDCCH candidate in the at least one CORESET 508, the UE 502 may be configured to identify (at 510) the absence of the PDCCH candidate based on the associated absence of the DM-RS for the first CORESET symbol. In aspects, to identify the presence or the absence (at 510) of the PDCCH candidate in the at least one CORESET 508, the UE 502 may be configured to identify (at 510) the absence of the PDCCH candidate based on the associated absence of the DM-RS for the first CORESET.

The UE 502 may be configured to decode or refrain from decoding (at 512) the first CORESET symbol and the second CORESET symbol based on the presence or the absence of the PDCCH candidate in the at least one CORESET 508. The UE 502 may be configured to refrain from decoding (at 512) the first CORESET symbol and the second CORESET symbol including to skip decoding attempts associated with the PDCCH candidate. The UE 502 may be configured to refrain from decoding (at 512) the first CORESET symbol and the second CORESET symbol including to skip decoding attempts associated with the PDCCH candidate across the at least one CORESET 508. In some aspects, the DM-RS may be non-transparent, and the UE 502 may be configured to decode (at 512) the first CORESET symbol and the second CORESET symbol. In such aspects, the UE 502 may be further configured to estimate a joint channel across the first CORESET symbol and the second CORESET symbol based on the DM-RS being non-transparent. Additionally, the first precoder granularity may be associated with a codebook-based precoder cycle associated with REGs on the first CORESET symbol, and the second precoder granularity may be associated with a common WB precoder for the second CORESET symbol. In such aspects, a step size of the codebook-based precoder cycle may be equal to the first precoder granularity associated with the first CORESET symbol.

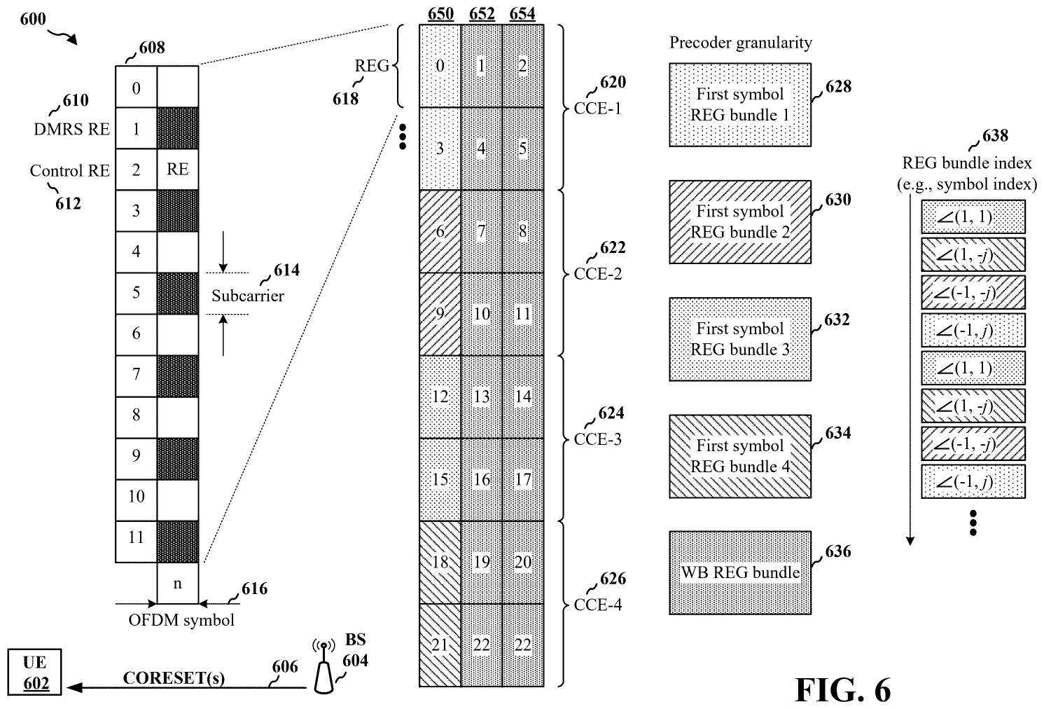

FIG. 6 is a diagram 600 illustrating an example of precoder granularities for DM-RS based PDCCH pruning, in various aspects. Diagram 600 may be an aspect of the call flow diagram 500 in FIG. 5 and is shown in the context of a UE 602 that receives at least one CORESET 606 from a network node (e.g., a base station 604, a gNB, etc.). Diagram 600 may be illustrative of a variable DM-RS bundle for PDCCH detection within a 3-symbol CORESET (e.g., of the at least one CORESET 606).

While the at least one CORESET 606 may comprise a 1- or 2-symbol CORESET, a 3-symbol CORESET (e.g., a symbol at 650, a symbol at 652, a symbol at 654) is provided by way of example and illustration. The at least one CORESET 606 may comprise a number of REGs (e.g., instances of a REG 618) such as 6 REGs per CCE that make up a number of CCEs (e.g., a CCE-1 620, a CCE-2 622, a CCE-3 624, a CCE-4 626) such as 1, 2, 4, 8, 16 CCEs. Each instance of the REG 618 may include a number of REs 608 (e.g., 12; e.g., 0 to 11) including at least one DM-RS RE 610/control RE 612, a subcarrier 614, and an OFDM symbol 616.

Aspects herein provide for multiple precoder granularities across different CORESET symbols. For instance, the base station 604 may configure the UE 602 with a precoder granularity configuration (e.g., the precoder granularity configuration 506 in FIG. 5) that may be indicative of multiple precoder granularities (e.g., a precoder granularity 628, a precoder granularity 630, a precoder granularity 632, a precoder granularity 634, a precoder granularity 636) for a specific CORESET within the at least one CORESET 606. In such aspects, each precoder granularity may be associated with the corresponding CORESET symbol index 638.

With respect to a first symbol (e.g., at 650) of the at least one CORESET 606, a precoder granularity (e.g., the precoder granularity 628, the precoder granularity 630, the precoder granularity 632, the precoder granularity 634) may be configurable. In one example, the precoder granularity may be the same as a number of REGs (instances of the REG 618) in the FD for a narrow band (NB) REG bundle (within a CCE: e.g., the CCE-1 620, the CCE-2 622, the CCE-3 624, the CCE-4 626). For instance, a precoder granularity (e.g., the precoder granularity 628, the precoder granularity 630, the precoder granularity 632, the precoder granularity 634) may be configured as 6, 3, 2, 1 (e.g., in 5G NR, the number of REGs in the FD for a REG bundle may be 6, or may be 2 when a CORESET is one symbol). In another example, when a CCE-to-REG mapping is non-interleaving, a precoder granularity (e.g., the precoder granularity 628, the precoder granularity 630, the precoder granularity 632, the precoder granularity 634) may be associated with a number of REGs in each CCE, an aggregation level (AL) or minimum thereof, and a number of CORESET symbols in the at least one CORESET 606. For instance, a precoder granularity may be configured as:

$$\frac{\# of REGs per CCE * min AL}{\# of CORESET symbols} .$$

In aspects, if the CCE-to-REG mapping is or changes to interleaving, the precoder granularity may fall back to the interleaving option noted above. With respect to the following symbols (e.g., at 652, at 654), the precoder granularity may be configured as an existing granularity, e.g., the precoder granularity 636, in various aspects, as noted herein: e.g., either sameAsREG-bundle or allContiguousRBs (e.g., WB). If the base station 604 configures the UE 602 with a single precoder granularity, the UE 602 may fall back to an existing granularity, in various aspects, as noted herein: e.g., either sameAsREG-bundle or allContiguousRBs. In some cases, if the precoder granularity is configured to allContiguousRBs, the UE 602 may use the DM-RS with additional information to determine the existence of a given, specific PDCCH candidate. In some aspects, if the base station 604 configures the UE 602 with a WB precoder granularity for its PDCCH, the base station 604 may configure two precoder granularities where the first symbol (e.g., at 650) may use a small-sized precoder granularity to enable the UE 602 side DM-RS based PDCCH pruning at an early stage of processing, and the remaining symbols (e.g., at 652, at 654) may use a WB precoder granularity to enhance DM-RS channel estimation.

In aspects, to enable the joint channel estimation across all the CORESET symbols of the at least one CORESET 606, a DM-RS transmission at the first symbol (e.g., at 650) may be non-transparent. In some aspects, there may be codebook-based precoder cycling for the REGs 618 on the first symbol, and a common WB precoder for all the REGs 618 within the at least one CORESET 606. A precoder cycling step size may be, or may be configured as, the same size as the precoder granularity (e.g., the precoder granularity 628, the precoder granularity 630, the precoder granularity 632, the precoder granularity 634) configured for the first symbol (e.g., at 650).

Aspects also provide for multiple precoder granularities across different CORESETs. For instance, the base station 604 may configure the UE 602 for multiple CORESETs (e.g., of the at least one CORESET 606). In such aspects, the multiple CORESETs may be mapped to the same search space set, and precoder granularities may be configured for CORESETs of the at least one CORESET 606 (e.g., rather than for CORESET symbols, as described herein).

With respect to a first CORESET of the at least one CORESET 606, which may have a higher DM-RS density than following CORESETs, a precoder granularity (e.g., the precoder granularity 628, the precoder granularity 630, the precoder granularity 632, the precoder granularity 634) may be configurable. In one example, the precoder granularity may be the same as a number of REGs (instances of the REG 618) in the FD for a narrow band (NB) REG bundle (within a CCE: e.g., the CCE-1 620, the CCE-2 622, the CCE-3 624, the CCE-4 626), as noted herein. In another example, when a CCE-to-REG mapping is non-interleaving, a precoder granularity (e.g., the precoder granularity 628, the precoder granularity 630, the precoder granularity 632, the precoder granularity 634) may be associated with a number of REGs in each CCE, an aggregation level (AL) or minimum thereof, and a number of CORESET symbols in the at least one CORESET 606. For instance, a precoder granularity may be configured as:

$$\frac{\# of REGs per CCE * min AL}{\# of CORESET symbols} .$$

In aspects, if the CCE-to-REG mapping is or changes to interleaving, the precoder granularity may fall back to the interleaving option noted above. With respect to the following CORESETs, the precoder granularity may be configured as an existing granularity, e.g., the precoder granularity 636, in various aspects, as noted herein: e.g., either sameAsREG-bundle or allContiguousRBs, or may be configured with a NB precoder granularity.

In various aspects, e.g., to facilitate increased power savings, a detection/determination of an absence of a DM-RS for a first symbol of a CORESET may enable the UE 602 to prune/skip PDCCH detection attempts for following symbols; likewise, a detection/determination of an absence of a DM-RS for a first CORESET of multiple CORESETs may enable the UE 602 to prune/skip PDCCH detection attempts for following CORESETs of the multiple CORESETs.

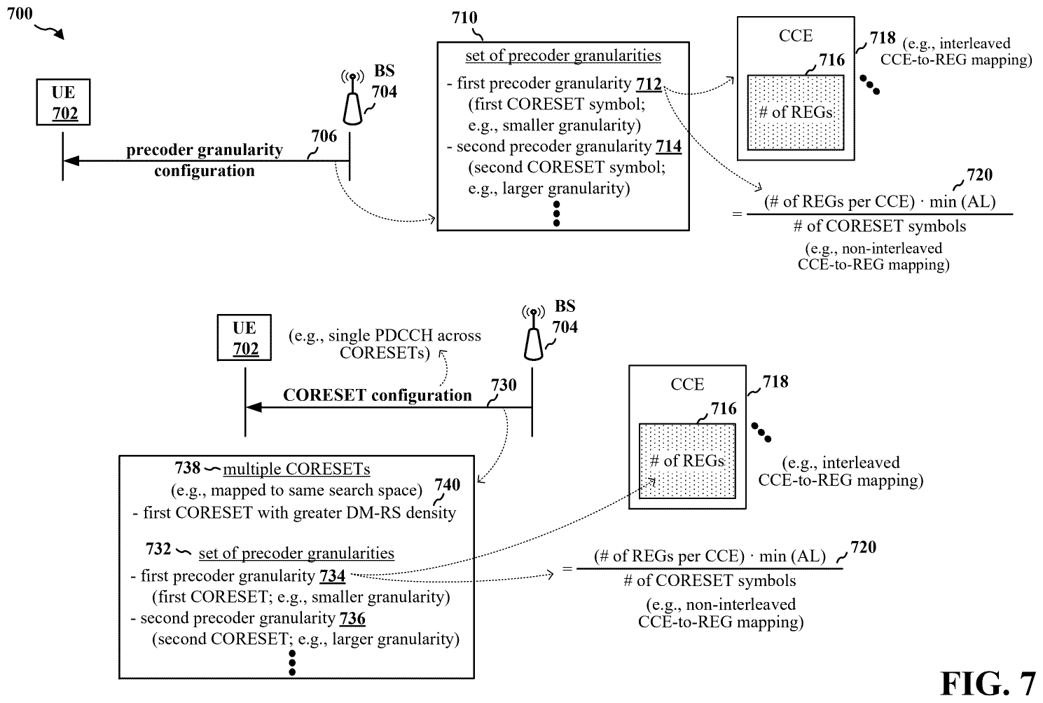

FIG. 7 is a diagram 700 illustrating an example of precoder granularities for DM-RS based PDCCH pruning, in various aspects. Diagram 700 may be an aspect of the call flow diagram 500 in FIG. 5 and is shown in the context of a UE 702 that receives configurations from a network node (e.g., a base station 704, a gNB, etc.).

The UE 702 may be configured to receive, and the base station 704 may be configured to transmit/provide/configure, a precoder granularity configuration 706. The precoder granularity configuration 706 may be indicative of a set of precoder granularities 710 that includes at least a first precoder granularity 712 and a second precoder granularity 714 for a CORESET(s). In aspects, the first precoder granularity 712 may be associated with a first CORESET symbol of the CORESET(s), and the second precoder granularity 714 may be associated with a second CORESET symbol of the at least one CORESET(s). The second precoder granularity 714 may be different than the first precoder granularity 712. In aspects, the second precoder granularity 714 may be a WB precoder granularity, and the first precoder granularity 712 may be a smaller precoder granularity than the WB precoder granularity.

The UE 702 may be configured to receive, and the base station 704 may be configured to transmit/provide/configure, a CORESET configuration 730. The CORESET configuration 730 may be indicative of a set of precoder granularities 732 that includes at least a first precoder granularity 734 and a second precoder granularity 736 for a CORESET(s). In aspects, the first precoder granularity 734 may be associated with a first CORESET of the CORESET(s), and the second precoder granularity 736 may be associated with a second CORESET of the CORESET(s). The second precoder granularity 736 may be different than the first precoder granularity 734. In aspects, the second precoder granularity 736 may be a WB precoder granularity, or may be a NB precoder granularity, and the first precoder granularity 734 may be a smaller precoder granularity than a WB precoder granularity. Additionally, the CORESET configuration 730 may be indicative of multiple CORESETs 738 (e.g., as at least one CORESET, described herein) that may be mapped to a same search space set. A first CORESET of the multiple CORESETs 738 may be configured for transmission/reception first among the multiple CORESETs 738. Such a first CORESET may have a greater DM-RS density 740 than following CORESETs of the multiple CORESETs 738 and/or may have the first precoder granularity 734 (e.g., a smaller/finer granularity than a WB precoder granularity). In some aspects, a PDCCH candidate for the multiple CORESETs 738 may be a single PDCCH that is associated with each CORESET of the multiple CORESETs 738.

In aspects, the first precoder granularity 712 and/or the first precoder granularity 734 may be equal to a number of REGs 716 in a frequency domain (FD) for a NB REG bundle within a CCE 718 associated with the CORESET(s) (e.g., for interleaved CCE-to-REG mappings). In some aspects, a CCE-to-REG mapping may be non-interleaved, and the first precoder granularity 712 and/or the first precoder granularity 734 may be associated with a number of REGs in each CCE, an aggregation level or minimum thereof, and a number of CORESET symbols in the CORESET(s), such as a precoder granularity relation 720, which may be:

$$\frac{\# of REGs per CCE * min AL}{\# of CORESET symbols} .$$

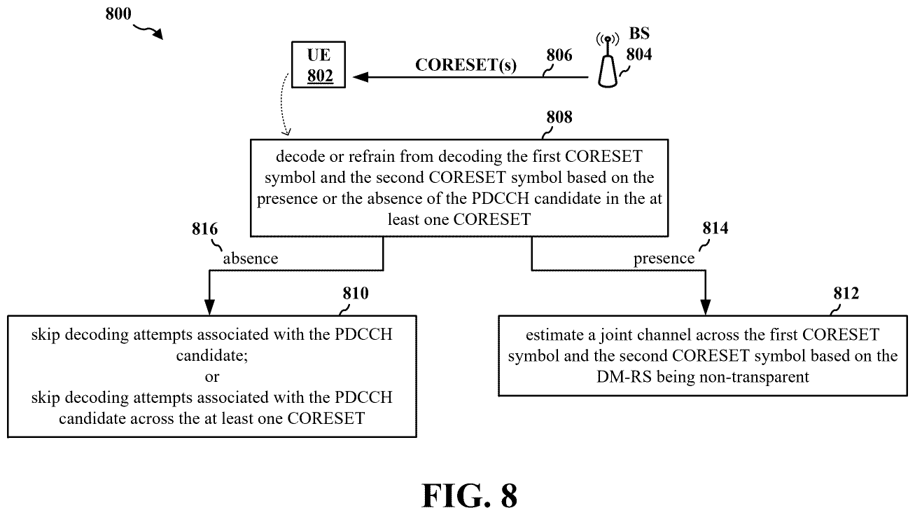

FIG. 8 is a diagram 800 illustrating an example of precoder granularities for DM-RS based PDCCH pruning, in various aspects. Diagram 800 may be an aspect of the call flow diagram 500 in FIG. 5 and is shown in the context of a UE 802 that decodes or refrains from decoding a PDCCH(s) associated with at least one CORESET received from a network node (e.g., a base station 804, a gNB, etc.).

As noted herein, a UE may receive a CORESET(s) from a network node. For instance, the UE 802 may be configured to receive, and the base station 804 may be configured to transmit/provide, a CORESET(s) 806. The CORESET(s) 806 may or may not include a PDCCH candidate, and the UE 802 may be configured to identify (e.g., at 510 in FIG. 5) a presence 814 or an absence 816 of a PDCCH candidate in the CORESET(s) 806 based on an associated presence 814 or an associated absence 816 of a DM-RS therein. Accordingly, the UE 802 may be configured to decode or refrain from decoding (at 808) the first CORESET symbol and the second CORESET symbol based on the presence 814 or the absence 816 of the PDCCH candidate in the CORESET(s) 806.

In aspects, based on the absence 816 of the PDCCH candidate and the UE 802 being configured to refrain from decoding (at 808), the UE 802 may be configured to skip (at 810) decoding attempts associated with the PDCCH candidate. For example, the UE 802 may be configured to skip (at 810) decoding attempts associated with the PDCCH candidate for subsequent symbols of the CORESET(s) 806 and/or associated with the PDCCH candidate (e.g., as a single candidate) for subsequent CORESETs of the CORESET(s) 806 (e.g., as multiple CORESETs).

In other aspects, based on the presence 814 of the PDCCH candidate and the UE 802 being configured to decode (at 808), the UE 802 may be configured to estimate (at 812) a joint channel across the first CORESET symbol and the second CORESET symbol when the DM-RS is non-transparent. In such aspects, the base station 804 may be configured to transmit/provide the DM-RS with the CORESETs 806 to the UE 802 for an estimation of a joint channel across the first CORESET symbol and the second CORESET symbol based on the DM-RS being non-transparent. For instance, a first precoder granularity may be associated with a codebook-based precoder cycle associated with REGs on the first CORESET symbol, and the second precoder granularity may be associated with a common WB precoder for the second CORESET symbol, as described herein. In such aspects, a step size of the codebook-based precoder cycle may be equal to the first precoder granularity associated with the first CORESET symbol.

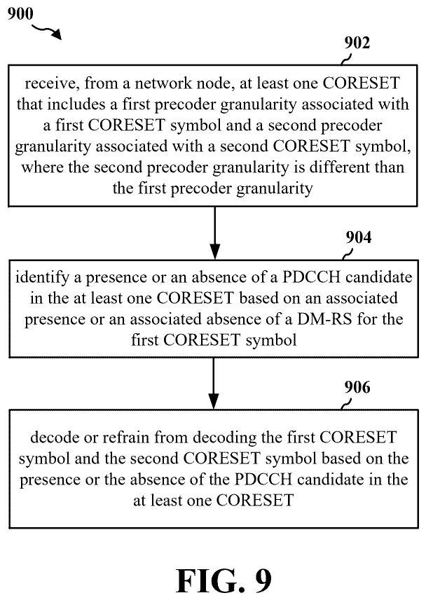

FIG. 9 is a flowchart 900 of a method of wireless communication. The method may be performed by a UE (e.g., the UE 104, 402, 502, 602, 702, 802; the apparatus 1204). The method may be for precoder granularities for DM-RS based PDCCH pruning. The method may enable PDCCH pruning/absence detection based on improved DM-RS configurations, may enable an earlier PDCCH absence detection based on the improved DM-RS configurations and increase power savings, and may enable a reduction in PDCCH blind decoding hardware footprint by improving PDCCH pruning based on the DM-RS configurations.

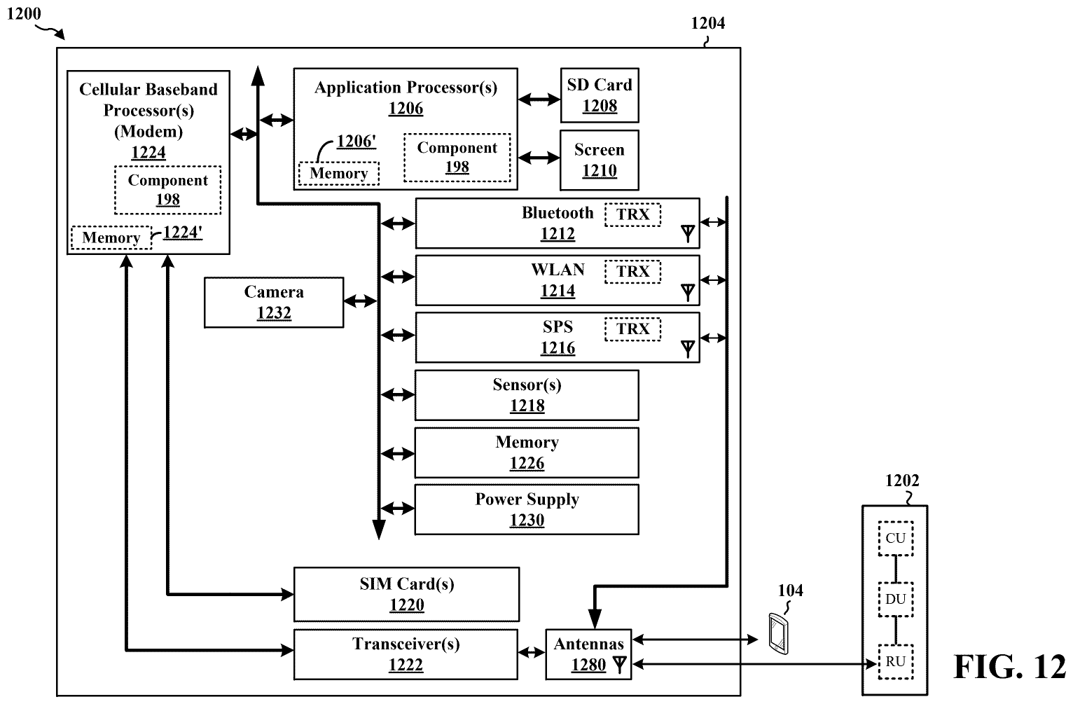

At 902, the UE receives, from a network node, at least one CORESET that includes a first precoder granularity associated with a first CORESET symbol and a second precoder granularity associated with a second CORESET symbol, where the second precoder granularity is different than the first precoder granularity. As an example, the reception may be performed by one or more of the component 198, the transceiver(s) 1222, and/or the antenna 1280 in FIG. 12. FIG. 5 illustrates, in the context of FIGS. 6, 7, 8, an example of the UE 502 receiving such a CORESET(s) from a network node (e.g., the base station 504).

The UE 502 may be configured to receive, and the base station 504 may be configured to transmit/provide/configure, a precoder granularity configuration 506 (e.g., 706 in FIG. 7). The precoder granularity configuration 506 (e.g., 706 in FIG. 7) may be indicative of a set of precoder granularities (e.g., 710, 732 in FIG. 7) that includes at least a first precoder granularity (e.g., 712, 720, 734 in FIG. 7) and a second precoder granularity (e.g., 714, 736 in FIG. 7) for a CORESET(s) (e.g., at least one CORESET 508 (e.g., 606 in FIG. 6; 738 in FIG. 7; 806 in FIG. 8). In other words, the base station 504 may configure the UE 502 with the precoder granularity configuration 506 (e.g., 706 in FIG. 7) that is indicative of a set of precoder granularities (e.g., 710, 732 in FIG. 7) for the at least one CORESET 508 (e.g., 606 in FIG. 6; 738 in FIG. 7; 806 in FIG. 8). In aspects, the set of precoder granularities (e.g., 710, 732 in FIG. 7) may include a first precoder granularity (e.g., 712, 720, 734 in FIG. 7) associated with a first CORESET symbol (e.g., 650 in FIG. 6) of the at least one CORESET 508 (e.g., 606 in FIG. 6; 738 in FIG. 7; 806 in FIG. 8) and a second precoder granularity (e.g., 714, 736 in FIG. 7) associated with a second CORESET symbol (e.g., 652 in FIG. 6) of the at least one CORESET 508 (e.g., 606 in FIG. 6; 738 in FIG. 7; 806 in FIG. 8), and the second precoder granularity (e.g., 714, 736 in FIG. 7) may be different than the first precoder granularity (e.g., 712, 720, 734 in FIG. 7). In aspects, the first precoder granularity (e.g., 712, 720, 734 in FIG. 7) associated with the first CORESET symbol (e.g., 650 in FIG. 6) may be equal to a first number of REGs (e.g., 618 in FIG. 6; 716 in FIG. 7) in a frequency domain for a narrow band REG bundle (e.g., 628, 630, 632, 634 in FIG. 6) within a CCE (e.g., 620, 622, 624, 626 in FIG. 6; 718 in FIG. 7) associated with the at least one CORESET 508 (e.g., 606 in FIG. 6; 738 in FIG. 7; 806 in FIG. 8). In some aspects, a CCE-to-REG mapping may be non-interleaved and the first precoder granularity (e.g., 712, 720, 734 in FIG. 7) associated with the first CORESET symbol (e.g., 650 in FIG. 6) may be associated with a second number of REGs (e.g., 618 in FIG. 6; 716 in FIG. 7) in each CCE (e.g., 620, 622, 624, 626 in FIG. 6; 718 in FIG. 7), an aggregation level, and a third number of CORESET symbols (e.g., 654 in FIG. 6) in the at least one CORESET 508 (e.g., 606 in FIG. 6; 738 in FIG. 7; 806 in FIG. 8). In aspects, the second precoder granularity may be a WB precoder granularity (e.g., for a WB REG bundle (e.g., 636 in FIG. 6)) and the first precoder granularity (e.g., 712, 720, 734 in FIG. 7) may be a smaller precoder granularity than the WB precoder granularity (e.g., for a WB REG bundle (e.g., 636 in FIG. 6)).

The UE 502 may be configured to receive, from a network node (e.g., the base station 504, which may be configured to transmit/provide), the at least one CORESET 508 (e.g., 606 in FIG. 6; 738 in FIG. 7; 806 in FIG. 8) that may include the first precoder granularity (e.g., 712, 720, 734 in FIG. 7) associated with a first CORESET symbol (e.g., 650 in FIG. 6) and the second precoder granularity (e.g., 714, 736 in FIG. 7) associated with a second CORESET symbol (e.g., 652 in FIG. 6) of the at least one CORESET 508 (e.g., 606 in FIG. 6; 738 in FIG. 7; 806 in FIG. 8). In aspects, the first CORESET symbol (e.g., 650 in FIG. 6) may include a one-to-one mapping between the DM-RS and the PDCCH candidate. In some aspects, the first CORESET symbol (e.g., 650 in FIG. 6) and the second CORESET symbol (e.g., 652 in FIG. 6) are of a same CORESET of the at least one CORESET 508 (e.g., 606 in FIG. 6; 738 in FIG. 7; 806 in FIG. 8). The first precoder granularity (e.g., 712, 720, 734 in FIG. 7) may be associated with a first symbol index (e.g., 638 in FIG. 6) of the first CORESET symbol (e.g., 650 in FIG. 6) and the second precoder granularity (e.g., 714, 736 in FIG. 7) may be associated with a second symbol index (e.g., 638 in FIG. 6) of the second CORESET symbol (e.g., 652 in FIG. 6). In aspects, the first symbol index (e.g., 638 in FIG. 6) may be different than the second symbol index (e.g., 638 in FIG. 6). In some aspects, the first CORESET symbol (e.g., 650 in FIG. 6) and the second CORESET symbol (e.g., 652 in FIG. 6) may be of different CORESETs of the at least one CORESET 508 (e.g., 606 in FIG. 6; 738 in FIG. 7; 806 in FIG. 8). For example, the different CORESETs may include a first CORESET and a second CORESET, and the first CORESET symbol (e.g., 650 in FIG. 6) and the second CORESET symbol (e.g., 652 in FIG. 6) may include a search space mapping to a same search space set. In such aspects, the PDCCH candidate may be a single PDCCH that is associated with each CORESET of the at least one CORESET 508 (e.g., 606 in FIG. 6; 738 in FIG. 7; 806 in FIG. 8). The first CORESET may be configured with a higher DM-RS density (e.g., 740 in FIG. 7) than other CORESETs of the at least one CORESET (e.g., 606 in FIG. 6; 738 in FIG. 7; 806 in FIG. 8), in various configurations. In some aspects, the first CORESET may be configured at a beginning of the at least one CORESET 508 (e.g., 606 in FIG. 6; 738 in FIG. 7; 806 in FIG. 8) (e.g., may be an initial CORESET provided for the at least one CORESET 508 (e.g., 606 in FIG. 6; 738 in FIG. 7; 806 in FIG. 8)). In some aspects, the first precoder granularity (e.g., 712, 720, 734 in FIG. 7) may be different than a WB precoder granularity (e.g., for a WB REG bundle (e.g., 636 in FIG. 6)) and may be associated with the first CORESET, and the first precoder granularity (e.g., 712, 720, 734 in FIG. 7) may be equal to a first number of REGs (e.g., 618 in FIG. 6; 716 in FIG. 7) in a frequency domain for a narrow band REG bundle (e.g., 628, 630, 632, 634 in FIG. 6) within a CCE (e.g., 620, 622, 624, 626 in FIG. 6; 718 in FIG. 7) associated with the first CORESET. In some aspects, a CCE-to-REG mapping may be non-interleaved and the first precoder granularity (e.g., 712, 720, 734 in FIG. 7) associated with the first CORESET may be associated with a second number of REGs (e.g., 618 in FIG. 6; 716 in FIG. 7) in each CCE (e.g., 620, 622, 624, 626 in FIG. 6; 718 in FIG. 7), an aggregation level, and a third number of CORESET symbols (e.g., 654 in FIG. 6) in the first CORESET of the at least one CORESET 508 (e.g., 606 in FIG. 6; 738 in FIG. 7; 806 in FIG. 8).

At 904, the UE identifies a presence or an absence of a PDCCH candidate in the at least one CORESET based on an associated presence or an associated absence of a DM-RS for the first CORESET symbol. As an example, the identification may be performed by one or more of the component 198, the transceiver(s) 1222, and/or the antenna 1280 in FIG. 12. FIG. 5 illustrates, in the context of FIGS. 6, 7, 8, an example of the UE 502 identifying such a presence/absence of a PDCCH candidate.

The UE 502 may be configured to identify (at 510) a presence (e.g., 814 in FIG. 8) or an absence (e.g., 816 in FIG. 8) of a PDCCH candidate in the at least one CORESET 508 (e.g., 606 in FIG. 6; 738 in FIG. 7; 806 in FIG. 8) based on an associated presence (e.g., 814 in FIG. 8) or an associated absence (e.g., 816 in FIG. 8) of a DM-RS for the first CORESET symbol (e.g., 650 in FIG. 6). In aspects, to identify (at 510) the presence (e.g., 814 in FIG. 8) or the absence (e.g., 816 in FIG. 8) of the PDCCH candidate in the at least one CORESET 508 (e.g., 606 in FIG. 6; 738 in FIG. 7; 806 in FIG. 8), the UE 502 may be configured to identify (at 510) the absence (e.g., 816 in FIG. 8) of the PDCCH candidate based on the associated absence (e.g., 816 in FIG. 8) of the DM-RS for the first CORESET symbol (e.g., 650 in FIG. 6). In aspects, to identify the presence (e.g., 814 in FIG. 8) or the absence (e.g., 816 in FIG. 8) (at 510) of the PDCCH candidate in the at least one CORESET 508 (e.g., 606 in FIG. 6; 738 in FIG. 7; 806 in FIG. 8), the UE 502 may be configured to identify (at 510) the absence (e.g., 816 in FIG. 8) of the PDCCH candidate based on the associated absence (e.g., 816 in FIG. 8) of the DM-RS for the first CORESET.

At 906, the UE decodes or refrains from decoding the first CORESET symbol and the second CORESET symbol based on the presence or the absence of the PDCCH candidate in the at least one CORESET. As an example, the decode/refrain from decoding may be performed by one or more of the component 198, the transceiver(s) 1222, and/or the antenna 1280 in FIG. 12. FIG. 5 illustrates, in the context of FIGS. 6, 7, 8, an example of the UE 502 decoding or refraining from decoding such CORESET symbols.

The UE 502 may be configured to decode or refrain from decoding (at 512) (e.g., 808 in FIG. 8) the first CORESET symbol (e.g., 650 in FIG. 6) and the second CORESET symbol (e.g., 652 in FIG. 6) based on the presence (e.g., 814 in FIG. 8) or the absence (e.g., 816 in FIG. 8) of the PDCCH candidate in the at least one CORESET 508 (e.g., 606 in FIG. 6; 738 in FIG. 7; 806 in FIG. 8). The UE 502 may be configured to refrain from decoding (at 512) (e.g., 808 in FIG. 8) the first CORESET symbol (e.g., 650 in FIG. 6) and the second CORESET symbol (e.g., 652 in FIG. 6) including to skip (e.g., 810 in FIG. 8) decoding attempts associated with the PDCCH candidate. The UE 502 may be configured to refrain from decoding (at 512) (e.g., 808 in FIG. 8) the first CORESET symbol (e.g., 650 in FIG. 6) and the second CORESET symbol (e.g., 652 in FIG. 6) including to skip (e.g., 810 in FIG. 8) decoding attempts associated with the PDCCH candidate across the at least one CORESET 508 (e.g., 606 in FIG. 6; 738 in FIG. 7; 806 in FIG. 8). In some aspects, the DM-RS may be non-transparent, and the UE may be configured to decode (at 512) (e.g., 808 in FIG. 8) the first CORESET symbol (e.g., 650 in FIG. 6) and the second CORESET symbol (e.g., 652 in FIG. 6). In such aspects, the UE 502 may be further configured to estimate (e.g., 812 in FIG. 8) a joint channel across the first CORESET symbol (e.g., 650 in FIG. 6) and the second CORESET symbol (e.g., 652 in FIG. 6) based on the DM-RS being non-transparent. Additionally, the first precoder granularity (e.g., 712, 720, 734 in FIG. 7) may be associated with a codebook-based precoder cycle associated with REGs (e.g., 618 in FIG. 6; 716 in FIG. 7) on the first CORESET symbol (e.g., 650 in FIG. 6), and the second precoder granularity (e.g., 714, 736 in FIG. 7) may be associated with a common WB precoder for the second CORESET symbol (e.g., 652 in FIG. 6). In such aspects, a step size of the codebook-based precoder cycle may be equal to the first precoder granularity (e.g., 712, 720, 734 in FIG. 7) associated with the first CORESET symbol (e.g., 650 in FIG. 6).

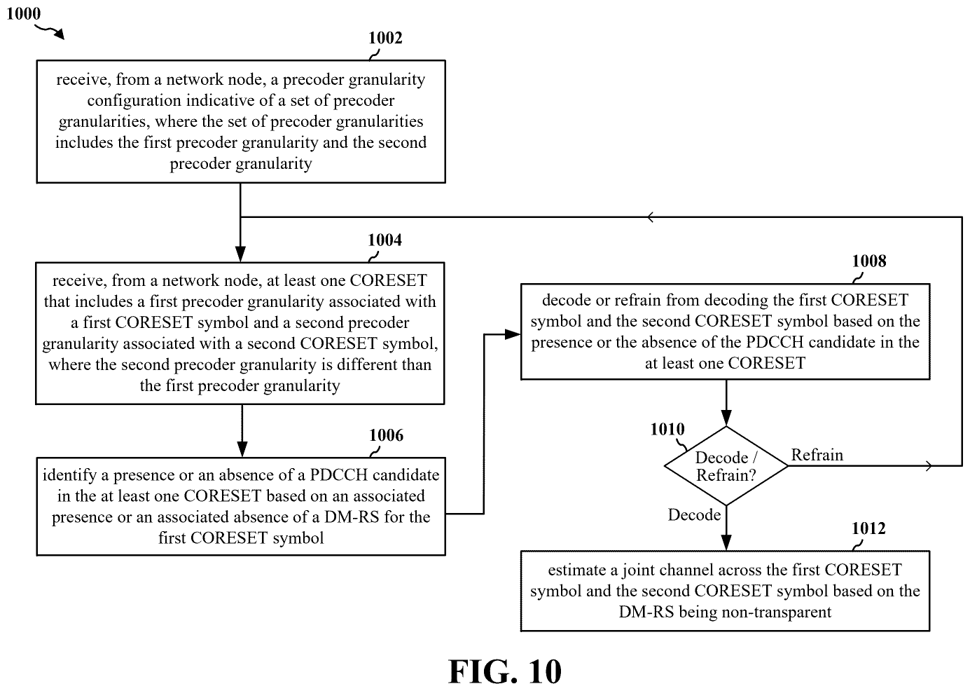

FIG. 10 is a flowchart 1000 of a method of wireless communication. The method may be performed by a UE (e.g., the UE 104, 402, 502, 602, 702, 802; the apparatus 1204). The method may be for precoder granularities for DM-RS based PDCCH pruning. The method may enable PDCCH pruning/absence detection based on improved DM-RS configurations, may enable an earlier PDCCH absence detection based on the improved DM-RS configurations and increase power savings, and may enable a reduction in PDCCH blind decoding hardware footprint by improving PDCCH pruning based on the DM-RS configurations.

At 1002, the UE receives, from a network node, a precoder granularity configuration indicative of a set of precoder granularities, where the set of precoder granularities includes the first precoder granularity and the second precoder granularity. As an example, the reception may be performed by one or more of the component 198, the transceiver(s) 1222, and/or the antenna 1280 in FIG. 12. FIG. 5 illustrates, in the context of FIGS. 6, 7, 8, an example of the UE 502 receiving such a precoder granularity configuration from a network node (e.g., the base station 504).

The UE 502 may be configured to receive, and the base station 504 may be configured to transmit/provide/configure, a precoder granularity configuration 506 (e.g., 706 in FIG. 7). The precoder granularity configuration 506 (e.g., 706 in FIG. 7) may be indicative of a set of precoder granularities (e.g., 710, 732 in FIG. 7) that includes at least a first precoder granularity (e.g., 712, 720, 734 in FIG. 7) and a second precoder granularity (e.g., 714, 736 in FIG. 7) for a CORESET(s) (e.g., at least one CORESET 508 (e.g., 606 in FIG. 6; 738 in FIG. 7; 806 in FIG. 8). In other words, the base station 504 may configure the UE 502 with the precoder granularity configuration 506 (e.g., 706 in FIG. 7) that is indicative of a set of precoder granularities (e.g., 710, 732 in FIG. 7) for the at least one CORESET 508 (e.g., 606 in FIG. 6; 738 in FIG. 7; 806 in FIG. 8). In aspects, the set of precoder granularities (e.g., 710, 732 in FIG. 7) may include a first precoder granularity (e.g., 712, 720, 734 in FIG. 7) associated with a first CORESET symbol (e.g., 650 in FIG. 6) of the at least one CORESET 508 (e.g., 606 in FIG. 6; 738 in FIG. 7; 806 in FIG. 8) and a second precoder granularity (e.g., 714, 736 in FIG. 7) associated with a second CORESET symbol (e.g., 652 in FIG. 6) of the at least one CORESET 508 (e.g., 606 in FIG. 6; 738 in FIG. 7; 806 in FIG. 8), and the second precoder granularity (e.g., 714, 736 in FIG. 7) may be different than the first precoder granularity (e.g., 712, 720, 734 in FIG. 7). In aspects, the first precoder granularity (e.g., 712, 720, 734 in FIG. 7) associated with the first CORESET symbol (e.g., 650 in FIG. 6) may be equal to a first number of REGs (e.g., 618 in FIG. 6; 716 in FIG. 7) in a frequency domain for a narrow band REG bundle (e.g., 628, 630, 632, 634 in FIG. 6) within a CCE (e.g., 620, 622, 624, 626 in FIG. 6; 718 in FIG. 7) associated with the at least one CORESET 508 (e.g., 606 in FIG. 6; 738 in FIG. 7; 806 in FIG. 8). In some aspects, a CCE-to-REG mapping may be non-interleaved and the first precoder granularity (e.g., 712, 720, 734 in FIG. 7) associated with the first CORESET symbol (e.g., 650 in FIG. 6) may be associated with a second number of REGs (e.g., 618 in FIG. 6; 716 in FIG. 7) in each CCE (e.g., 620, 622, 624, 626 in FIG. 6; 718 in FIG. 7), an aggregation level, and a third number of CORESET symbols (e.g., 654 in FIG. 6) in the at least one CORESET 508 (e.g., 606 in FIG. 6; 738 in FIG. 7; 806 in FIG. 8). In aspects, the second precoder granularity may be a WB precoder granularity (e.g., for a WB REG bundle (e.g., 636 in FIG. 6)) and the first precoder granularity (e.g., 712, 720, 734 in FIG. 7) may be a smaller precoder granularity than the WB precoder granularity (e.g., for a WB REG bundle (e.g., 636 in FIG. 6)).

At 1004, the UE receives, from a network node, at least one CORESET that includes a first precoder granularity associated with a first CORESET symbol and a second precoder granularity associated with a second CORESET symbol, where the second precoder granularity is different than the first precoder granularity. As an example, the reception may be performed by one or more of the component 198, the transceiver(s) 1222, and/or the antenna 1280 in FIG. 12. FIG. 5 illustrates, in the context of FIGS. 6, 7, 8, an example of the UE 502 receiving such a CORESET(s) from a network node (e.g., the base station 504).

The UE 502 may be configured to receive, from a network node (e.g., the base station 504, which may be configured to transmit/provide), the at least one CORESET 508 (e.g., 606 in FIG. 6; 738 in FIG. 7; 806 in FIG. 8) that may include the first precoder granularity (e.g., 712, 720, 734 in FIG. 7) associated with a first CORESET symbol (e.g., 650 in FIG. 6) and the second precoder granularity (e.g., 714, 736 in FIG. 7) associated with a second CORESET symbol (e.g., 652 in FIG. 6) of the at least one CORESET 508 (e.g., 606 in FIG. 6; 738 in FIG. 7; 806 in FIG. 8). In aspects, the first CORESET symbol (e.g., 650 in FIG. 6) may include a one-to-one mapping between the DM-RS and the PDCCH candidate. In some aspects, the first CORESET symbol (e.g., 650 in FIG. 6) and the second CORESET symbol (e.g., 652 in FIG. 6) are of a same CORESET of the at least one CORESET 508 (e.g., 606 in FIG. 6; 738 in FIG. 7; 806 in FIG. 8). The first precoder granularity (e.g., 712, 720, 734 in FIG. 7) may be associated with a first symbol index (e.g., 638 in FIG. 6) of the first CORESET symbol (e.g., 650 in FIG. 6) and the second precoder granularity (e.g., 714, 736 in FIG. 7) may be associated with a second symbol index (e.g., 638 in FIG. 6) of the second CORESET symbol (e.g., 652 in FIG. 6). In aspects, the first symbol index (e.g., 638 in FIG. 6) may be different than the second symbol index (e.g., 638 in FIG. 6). In some aspects, the first CORESET symbol (e.g., 650 in FIG. 6) and the second CORESET symbol (e.g., 652 in FIG. 6) may be of different CORESETs of the at least one CORESET 508 (e.g., 606 in FIG. 6; 738 in FIG. 7; 806 in FIG. 8). For example, the different CORESETs may include a first CORESET and a second CORESET, and the first CORESET symbol (e.g., 650 in FIG. 6) and the second CORESET symbol (e.g., 652 in FIG. 6) may include a search space mapping to a same search space set. In such aspects, the PDCCH candidate may be a single PDCCH that is associated with each CORESET of the at least one CORESET 508 (e.g., 606 in FIG. 6; 738 in FIG. 7; 806 in FIG. 8). The first CORESET may be configured with a higher DM-RS density (e.g., 740 in FIG. 7) than other CORESETs of the at least one CORESET (e.g., 606 in FIG. 6; 738 in FIG. 7; 806 in FIG. 8), in various configurations. In some aspects, the first CORESET may be configured at a beginning of the at least one CORESET 508 (e.g., 606 in FIG. 6; 738 in FIG. 7; 806 in FIG. 8) (e.g., may be an initial CORESET provided for the at least one CORESET 508 (e.g., 606 in FIG. 6; 738 in FIG. 7; 806 in FIG. 8)). In some aspects, the first precoder granularity (e.g., 712, 720, 734 in FIG. 7) may be different than a WB precoder granularity (e.g., for a WB REG bundle (e.g., 636 in FIG. 6)) and may be associated with the first CORESET, and the first precoder granularity (e.g., 712, 720, 734 in FIG. 7) may be equal to a first number of REGs (e.g., 618 in FIG. 6; 716 in FIG. 7) in a frequency domain for a narrow band REG bundle (e.g., 628, 630, 632, 634 in FIG. 6) within a CCE (e.g., 620, 622, 624, 626 in FIG. 6; 718 in FIG. 7) associated with the first CORESET. In some aspects, a CCE-to-REG mapping may be non-interleaved and the first precoder granularity (e.g., 712, 720, 734 in FIG. 7) associated with the first CORESET may be associated with a second number of REGs (e.g., 618 in FIG. 6; 716 in FIG. 7) in each CCE (e.g., 620, 622, 624, 626 in FIG. 6; 718 in FIG. 7), an aggregation level, and a third number of CORESET symbols (e.g., 654 in FIG. 6) in the first CORESET of the at least one CORESET 508 (e.g., 606 in FIG. 6; 738 in FIG. 7; 806 in FIG. 8).

At 1006, the UE identifies a presence or an absence of a PDCCH candidate in the at least one CORESET based on an associated presence or an associated absence of a DM-RS for the first CORESET symbol. As an example, the identification may be performed by one or more of the component 198, the transceiver(s) 1222, and/or the antenna 1280 in FIG. 12. FIG. 5 illustrates, in the context of FIGS. 6, 7, 8, an example of the UE 502 identifying such a presence/absence of a PDCCH candidate.

The UE 502 may be configured to identify (at 510) a presence (e.g., 814 in FIG. 8) or an absence (e.g., 816 in FIG. 8) of a PDCCH candidate in the at least one CORESET 508 (e.g., 606 in FIG. 6; 738 in FIG. 7; 806 in FIG. 8) based on an associated presence (e.g., 814 in FIG. 8) or an associated absence (e.g., 816 in FIG. 8) of a DM-RS for the first CORESET symbol (e.g., 650 in FIG. 6). In aspects, to identify (at 510) the presence (e.g., 814 in FIG. 8) or the absence (e.g., 816 in FIG. 8) of the PDCCH candidate in the at least one CORESET 508 (e.g., 606 in FIG. 6; 738 in FIG. 7; 806 in FIG. 8), the UE 502 may be configured to identify (at 510) the absence (e.g., 816 in FIG. 8) of the PDCCH candidate based on the associated absence (e.g., 816 in FIG. 8) of the DM-RS for the first CORESET symbol (e.g., 650 in FIG. 6). In aspects, to identify the presence (e.g., 814 in FIG. 8) or the absence (e.g., 816 in FIG. 8) (at 510) of the PDCCH candidate in the at least one CORESET 508 (e.g., 606 in FIG. 6; 738 in FIG. 7; 806 in FIG. 8), the UE 502 may be configured to identify (at 510) the absence (e.g., 816 in FIG. 8) of the PDCCH candidate based on the associated absence (e.g., 816 in FIG. 8) of the DM-RS for the first CORESET.

At 1008, the UE decodes or refrains from decoding the first CORESET symbol and the second CORESET symbol based on the presence or the absence of the PDCCH candidate in the at least one CORESET. As an example, the decode/refrain from decoding may be performed by one or more of the component 198, the transceiver(s) 1222, and/or the antenna 1280 in FIG. 12. FIG. 5 illustrates, in the context of FIGS. 6, 7, 8, an example of the UE 502 decoding or refraining from decoding such CORESET symbols.

The UE 502 may be configured to decode or refrain from decoding (at 512) (e.g., 808 in FIG. 8) the first CORESET symbol (e.g., 650 in FIG. 6) and the second CORESET symbol (e.g., 652 in FIG. 6) based on the presence (e.g., 814 in FIG. 8) or the absence (e.g., 816 in FIG. 8) of the PDCCH candidate in the at least one CORESET 508 (e.g., 606 in FIG. 6; 738 in FIG. 7; 806 in FIG. 8). The UE 502 may be configured to refrain from decoding (at 512) (e.g., 808 in FIG. 8) the first CORESET symbol (e.g., 650 in FIG. 6) and the second CORESET symbol (e.g., 652 in FIG. 6) including to skip (e.g., 810 in FIG. 8) decoding attempts associated with the PDCCH candidate. The UE 502 may be configured to refrain from decoding (at 512) (e.g., 808 in FIG. 8) the first CORESET symbol (e.g., 650 in FIG. 6) and the second CORESET symbol (e.g., 652 in FIG. 6) including to skip (e.g., 810 in FIG. 8) decoding attempts associated with the PDCCH candidate across the at least one CORESET 508 (e.g., 606 in FIG. 6; 738 in FIG. 7; 806 in FIG. 8). In some aspects, the DM-RS may be non-transparent, and the UE may be configured to decode (at 512) (e.g., 808 in FIG. 8) the first CORESET symbol (e.g., 650 in FIG. 6) and the second CORESET symbol (e.g., 652 in FIG. 6).

At 1010, the UE determines if a decode was performed or if a refrain from decoding was performed at 1208. As an example, the determination may be performed by one or more of the component 198, the transceiver(s) 1222, and/or the antenna 1280 in FIG. 12. If the UE determines that a decode was performed, flowchart 1000 may continue to 1212. If the UE determines that a refrain from decoding was performed, flowchart 1000 may return to 1204 or may end.

At 1012, the UE estimate a joint channel across the first CORESET symbol and the second CORESET symbol based on the DM-RS being non-transparent. As an example, the estimation may be performed by one or more of the component 198, the transceiver(s) 1222, and/or the antenna 1280 in FIG. 12. FIG. 5 illustrates, in the context of FIGS. 6, 7, 8, an example of the UE 502 estimating such a joint channel.

As noted, in some aspects, the DM-RS may be non-transparent, and the UE may be configured to decode (at 512) (e.g., 808 in FIG. 8) the first CORESET symbol (e.g., 650 in FIG. 6) and the second CORESET symbol (e.g., 652 in FIG. 6). In such aspects, the UE 502 may be further configured to estimate (e.g., 812 in FIG. 8) a joint channel across the first CORESET symbol (e.g., 650 in FIG. 6) and the second CORESET symbol (e.g., 652 in FIG. 6) based on the DM-RS being non-transparent. Additionally, the first precoder granularity (e.g., 712, 720, 734 in FIG. 7) may be associated with a codebook-based precoder cycle associated with REGs (e.g., 618 in FIG. 6; 716 in FIG. 7) on the first CORESET symbol (e.g., 650 in FIG. 6), and the second precoder granularity (e.g., 714, 736 in FIG. 7) may be associated with a common WB precoder for the second CORESET symbol (e.g., 652 in FIG. 6). In such aspects, a step size of the codebook-based precoder cycle may be equal to the first precoder granularity (e.g., 712, 720, 734 in FIG. 7) associated with the first CORESET symbol (e.g., 650 in FIG. 6).

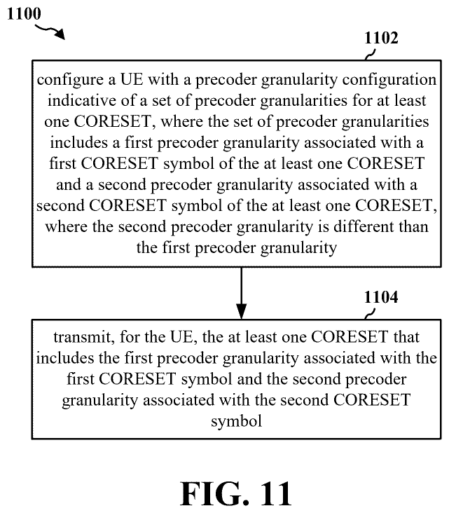

FIG. 11 is a flowchart 1100 of a method of wireless communication. The method may be performed by a base station (e.g., the base station 102, 504, 604, 704, 804; the network entity 1202, 1302). The method may be for precoder granularities for DM-RS based PDCCH pruning. The method may enable PDCCH pruning/absence detection based on improved DM-RS configurations, may enable an earlier PDCCH absence detection based on the improved DM-RS configurations and increase power savings, and may enable a reduction in PDCCH blind decoding hardware footprint by improving PDCCH pruning based on the DM-RS configurations.

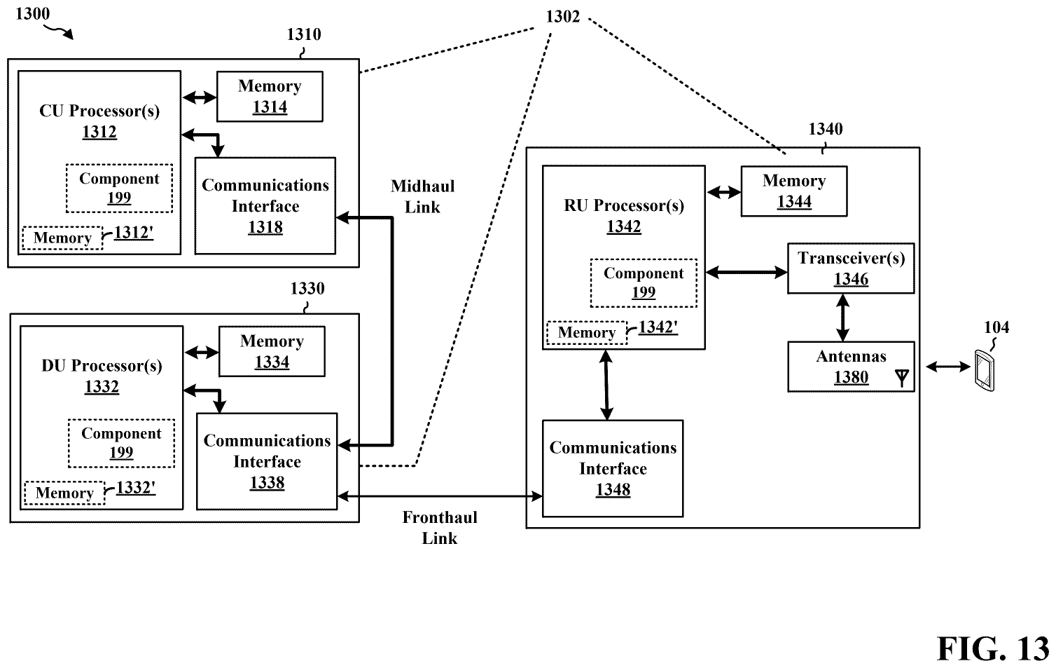

At 1102, the network node configures a UE with a precoder granularity configuration indicative of a set of precoder granularities for at least one CORESET, where the set of precoder granularities includes a first precoder granularity associated with a first CORESET symbol of the at least one CORESET and a second precoder granularity associated with a second CORESET symbol of the at least one CORESET, where the second precoder granularity is different than the first precoder granularity. As an example, the configuration may be performed by one or more of the component 199, the transceiver(s) 1346, and/or the antenna 1380 in FIG. 13. FIG. 5 illustrates, in the context of FIGS. 6, 7, 8, an example of a network node (e.g., the base station 504) configuring a UE (e.g., the UE 502) with such a precoder granularity configuration.

The base station 504 may be configured to transmit/provide/configure, and the UE 502 may be configured to receive, a precoder granularity configuration 506 (e.g., 706 in FIG. 7). The precoder granularity configuration 506 (e.g., 706 in FIG. 7) may be indicative of a set of precoder granularities (e.g., 710, 732 in FIG. 7) that includes at least a first precoder granularity (e.g., 712, 720, 734 in FIG. 7) and a second precoder granularity (e.g., 714, 736 in FIG. 7) for a CORESET(s) (e.g., at least one CORESET 508 (e.g., 606 in FIG. 6; 738 in FIG. 7; 806 in FIG. 8). In other words, the base station 504 may configure the UE 502 with the precoder granularity configuration 506 (e.g., 706 in FIG. 7) that is indicative of a set of precoder granularities (e.g., 710, 732 in FIG. 7) for the at least one CORESET 508 (e.g., 606 in FIG. 6; 738 in FIG. 7; 806 in FIG. 8). In aspects, the set of precoder granularities (e.g., 710, 732 in FIG. 7) may include a first precoder granularity (e.g., 712, 720, 734 in FIG. 7) associated with a first CORESET symbol (e.g., 650 in FIG. 6) of the at least one CORESET 508 (e.g., 606 in FIG. 6; 738 in FIG. 7; 806 in FIG. 8) and a second precoder granularity (e.g., 714, 736 in FIG. 7) associated with a second CORESET symbol (e.g., 652 in FIG. 6) of the at least one CORESET 508 (e.g., 606 in FIG. 6; 738 in FIG. 7; 806 in FIG. 8), and the second precoder granularity (e.g., 714, 736 in FIG. 7) may be different than the first precoder granularity (e.g., 712, 720, 734 in FIG. 7). In aspects, the first precoder granularity (e.g., 712, 720, 734 in FIG. 7) associated with the first CORESET symbol (e.g., 650 in FIG. 6) may be equal to a first number of REGs (e.g., 618 in FIG. 6; 716 in FIG. 7) in a frequency domain for a narrow band REG bundle (e.g., 628, 630, 632, 634 in FIG. 6) within a CCE (e.g., 620, 622, 624, 626 in FIG. 6; 718 in FIG. 7) associated with the at least one CORESET 508 (e.g., 606 in FIG. 6; 738 in FIG. 7; 806 in FIG. 8). In some aspects, a CCE-to-REG mapping may be non-interleaved and the first precoder granularity (e.g., 712, 720, 734 in FIG. 7) associated with the first CORESET symbol (e.g., 650 in FIG. 6) may be associated with a second number of REGs (e.g., 618 in FIG. 6; 716 in FIG. 7) in each CCE (e.g., 620, 622, 624, 626 in FIG. 6; 718 in FIG. 7), an aggregation level, and a third number of CORESET symbols (e.g., 654 in FIG. 6) in the at least one CORESET 508 (e.g., 606 in FIG. 6; 738 in FIG. 7; 806 in FIG. 8). In aspects, the second precoder granularity may be a WB precoder granularity (e.g., for a WB REG bundle (e.g., 636 in FIG. 6)) and the first precoder granularity (e.g., 712, 720, 734 in FIG. 7) may be a smaller precoder granularity than the WB precoder granularity (e.g., for a WB REG bundle (e.g., 636 in FIG. 6)).

At 1104, the network node transmits, for the UE, the at least one CORESET that includes the first precoder granularity associated with the first CORESET symbol and the second precoder granularity associated with the second CORESET symbol. As an example, the transmission may be performed by one or more of the component 199, the transceiver(s) 1346, and/or the antenna 1380 in FIG. 13. FIG. 5 illustrates, in the context of FIGS. 6, 7, 8, an example of a network node (e.g., the base station 504) transmitting such a CORESET(s) for a UE (e.g., the UE 502).

The, base station 504, as a network node, which may be configured to transmit/provide, and UE 502 may be configured to receive, the at least one CORESET 508 (e.g., 606 in FIG. 6; 738 in FIG. 7; 806 in FIG. 8) that may include the first precoder granularity (e.g., 712, 720, 734 in FIG. 7) associated with a first CORESET symbol (e.g., 650 in FIG. 6) and the second precoder granularity (e.g., 714, 736 in FIG. 7) associated with a second CORESET symbol (e.g., 652 in FIG. 6) of the at least one CORESET 508 (e.g., 606 in FIG. 6; 738 in FIG. 7; 806 in FIG. 8). In aspects, the first CORESET symbol (e.g., 650 in FIG. 6) may include a one-to-one mapping between the DM-RS and the PDCCH candidate. In some aspects, the first CORESET symbol (e.g., 650 in FIG. 6) and the second CORESET symbol (e.g., 652 in FIG. 6) are of a same CORESET of the at least one CORESET 508 (e.g., 606 in FIG. 6; 738 in FIG. 7; 806 in FIG. 8). The first precoder granularity (e.g., 712, 720, 734 in FIG. 7) may be associated with a first symbol index (e.g., 638 in FIG. 6) of the first CORESET symbol (e.g., 650 in FIG. 6) and the second precoder granularity (e.g., 714, 736 in FIG. 7) may be associated with a second symbol index (e.g., 638 in FIG. 6) of the second CORESET symbol (e.g., 652 in FIG. 6). In aspects, the first symbol index (e.g., 638 in FIG. 6) may be different than the second symbol index (e.g., 638 in FIG. 6). In some aspects, the first CORESET symbol (e.g., 650 in FIG. 6) and the second CORESET symbol (e.g., 652 in FIG. 6) may be of different CORESETs of the at least one CORESET 508 (e.g., 606 in FIG. 6; 738 in FIG. 7; 806 in FIG. 8). For example, the different CORESETs may include a first CORESET and a second CORESET, and the first CORESET symbol (e.g., 650 in FIG. 6) and the second CORESET symbol (e.g., 652 in FIG. 6) may include a search space mapping to a same search space set. In such aspects, the PDCCH candidate may be a single PDCCH that is associated with each CORESET of the at least one CORESET 508 (e.g., 606 in FIG. 6; 738 in FIG. 7; 806 in FIG. 8). The first CORESET may be configured with a higher DM-RS density (e.g., 740 in FIG. 7) than other CORESETs of the at least one CORESET (e.g., 606 in FIG. 6; 738 in FIG. 7; 806 in FIG. 8), in various configurations. In some aspects, the first CORESET may be configured at a beginning of the at least one CORESET 508 (e.g., 606 in FIG. 6; 738 in FIG. 7; 806 in FIG. 8) (e.g., may be an initial CORESET provided for the at least one CORESET 508 (e.g., 606 in FIG. 6; 738 in FIG. 7; 806 in FIG. 8)). In some aspects, the first precoder granularity (e.g., 712, 720, 734 in FIG. 7) may be different than a WB precoder granularity (e.g., for a WB REG bundle (e.g., 636 in FIG. 6)) and may be associated with the first CORESET, and the first precoder granularity (e.g., 712, 720, 734 in FIG. 7) may be equal to a first number of REGs (e.g., 618 in FIG. 6; 716 in FIG. 7) in a frequency domain for a narrow band REG bundle (e.g., 628, 630, 632, 634 in FIG. 6) within a CCE (e.g., 620, 622, 624, 626 in FIG. 6; 718 in FIG. 7) associated with the first CORESET. In some aspects, a CCE-to-REG mapping may be non-interleaved and the first precoder granularity (e.g., 712, 720, 734 in FIG. 7) associated with the first CORESET may be associated with a second number of REGs (e.g., 618 in FIG. 6; 716 in FIG. 7) in each CCE (e.g., 620, 622, 624, 626 in FIG. 6; 718 in FIG. 7), an aggregation level, and a third number of CORESET symbols (e.g., 654 in FIG. 6) in the first CORESET of the at least one CORESET 508 (e.g., 606 in FIG. 6; 738 in FIG. 7; 806 in FIG. 8).

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive, from a network node, at least one CORESET that includes a first precoder granularity associated with a first CORESET symbol and a second precoder granularity associated with a second CORESET symbol, where the second precoder granularity is different than the first precoder granularity. The component 198 may be configured to identify a presence or an absence of a PDCCH candidate in the at least one CORESET based on an associated presence or an associated absence of a DM-RS for the first CORESET symbol. The component 198 may be configured to decode or refrain from decoding the first CORESET symbol and the second CORESET symbol based on the presence or the absence of the PDCCH candidate in the at least one CORESET. The component 198 may be configured to receive, from the network node, a precoder granularity configuration indicative of a set of precoder granularities, where the set of precoder granularities includes the first precoder granularity and the second precoder granularity. The component 198 may be configured to estimate a joint channel across the first CORESET symbol and the second CORESET symbol based on the DM-RS being non-transparent. The component 198 may be further configured to perform any of the aspects described in connection with the flowcharts in any of FIGS. 9, 10, 11 and/or any of the aspects performed by a UE for any of FIGS. 4-8. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving, from a network node, at least one CORESET that includes a first precoder granularity associated with a first CORESET symbol and a second precoder granularity associated with a second CORESET symbol, where the second precoder granularity is different than the first precoder granularity. In one configuration, the apparatus 1204, and in particular the cellular baseband processor(s) 1224 and/or the application processor(s) 1206, may include means for identifying a presence or an absence of a PDCCH candidate in the at least one CORESET based on an associated presence or an associated absence of a DM-RS for the first CORESET symbol. In one configuration, the apparatus 1204, and in particular the cellular baseband processor(s) 1224 and/or the application processor(s) 1206, may include means for decoding or refraining from decoding the first CORESET symbol and the second CORESET symbol based on the presence or the absence of the PDCCH candidate in the at least one CORESET. In one configuration, the apparatus 1204, and in particular the cellular baseband processor(s) 1224 and/or the application processor(s) 1206, may include means for receiving, from the network node, a precoder granularity configuration indicative of a set of precoder granularities, where the set of precoder granularities includes the first precoder granularity and the second precoder granularity. In one configuration, the apparatus 1204, and in particular the cellular baseband processor(s) 1224 and/or the application processor(s) 1206, may include means for estimating a joint channel across the first CORESET symbol and the second CORESET symbol based on the DM-RS being non-transparent. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a UE with a precoder granularity configuration indicative of a set of precoder granularities for at least one CORESET, where the set of precoder granularities includes a first precoder granularity associated with a first CORESET symbol of the at least one CORESET and a second precoder granularity associated with a second CORESET symbol of the at least one CORESET, where the second precoder granularity is different than the first precoder granularity. The component 199 may be configured to transmit, for the UE, the at least one CORESET that includes the first precoder granularity associated with the first CORESET symbol and the second precoder granularity associated with the second CORESET symbol. The component 199 may be further configured to perform any of the aspects described in connection with the flowcharts in any of FIGS. 9, 10, 11 and/or any of the aspects performed by a network node (e.g., a base station, a gNB, a network entity, etc.) for any of FIGS. 4-8. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for configuring a UE with a precoder granularity configuration indicative of a set of precoder granularities for at least one CORESET, where the set of precoder granularities includes a first precoder granularity associated with a first CORESET symbol of the at least one CORESET and a second precoder granularity associated with a second CORESET symbol of the at least one CORESET, where the second precoder granularity is different than the first precoder granularity. In one configuration, the network entity 1302 may include means for transmitting, for the UE, the at least one CORESET that includes the first precoder granularity associated with the first CORESET symbol and the second precoder granularity associated with the second CORESET symbol. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

DM-RS precoding may utilize a sameAsREG-bundle configuration (e.g., the precoding on associated PDCCH transmissions is the same within a resource element REG bundle, and the PDCCH DM-RS transmission is across the PRBs associated with the PDCCH) or an allContiguousRBs configuration (e.g., the precoding is the same across all REGs within the set of contiguous RBs in the CORESET, and the PDCCH DM-RS transmission is across the entire CORESET region). Currently, a DM-RS is mapped on all REGs on all the OFDM symbols of a given PDCCH candidate, the DM-RS density is the same on all REGs, and the DM-RS positions are evenly-distributed within a REG. A UE in LTE/5G NR performs multiple decoding attempts (e.g., up to 44 per slot for a NR UE) to check if DCI is present or not, and in such cases, PDCCH blind detection may be a major source of UE power consumption. Some current solutions provide for early termination of PDCCH monitoring in order to conserve power. However, when the CORESET is configured with a WB precoder granularity (e.g., allContiguousRBs), the DM-RS is mapped to all the REGs, and therefore, the DM-RS detection may not confirm whether there is a PDCCH for a specific UE, or which PDCCH candidate is transmitted. That is, in such cases, early detection of a control channel for a UE may not be possible based on current DM-RS configurations, and a UE may not be enabled to conserve power that is utilized to detect its PDCCH.

Aspects herein for precoder granularities for DM-RS based PDCCH pruning enable PDCCH pruning/absence detection based on improved DM-RS configurations. Aspects enable an earlier PDCCH absence detection based on the improved DM-RS configurations and increase power savings. Aspects also enable a reduction in PDCCH blind decoding hardware footprint by improving PDCCH pruning based on the DM-RS configurations.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network node, at least one control resource set (CORESET) that includes a first precoder granularity associated with a first CORESET symbol and a second precoder granularity associated with a second CORESET symbol, wherein the second precoder granularity is different than the first precoder granularity; identifying a presence or an absence of a physical downlink control channel (PDCCH) candidate in the at least one CORESET based on an associated presence or an associated absence of a demodulation reference signal (DM-RS) for the first CORESET symbol; and decoding or refraining from decoding the first CORESET symbol and the second CORESET symbol based on the presence or the absence of the PDCCH candidate in the at least one CORESET.

Aspect 2 is the method of aspect 1, further comprising: receiving, from the network node, a precoder granularity configuration indicative of a set of precoder granularities, wherein the set of precoder granularities includes the first precoder granularity and the second precoder granularity.

Aspect 3 is the method of any of aspects 1 and 2, wherein identifying the presence or the absence of the PDCCH candidate in the at least one CORESET includes identifying the absence of the PDCCH candidate based on the associated absence of the DM-RS for the first CORESET symbol; wherein refraining from decoding the first CORESET symbol and the second CORESET symbol includes skipping decoding attempts associated with the PDCCH candidate.

Aspect 4 is the method of aspect 3, wherein the first precoder granularity associated with the first CORESET symbol is equal to a first number of resource element (RE) groups (REGs) in a frequency domain for a narrow band REG bundle within a control channel element (CCE) associated with the at least one CORESET; or wherein a CCE-to-REG mapping is non-interleaved and the first precoder granularity associated with the first CORESET symbol is associated with a second number of REGs in each CCE, an aggregation level, and a third number of CORESET symbols in the at least one CORESET.

Aspect 5 is the method of aspect 3, wherein the second precoder granularity is a wideband (WB) precoder granularity and the first precoder granularity is a smaller precoder granularity than the WB precoder granularity.

Aspect 6 is the method of any of aspects 1 to 5, wherein the first CORESET symbol includes a one-to-one mapping between the DM-RS and the PDCCH candidate.

Aspect 7 is the method of any of aspects 1 to 5, wherein the first CORESET symbol and the second CORESET symbol are of a same CORESET of the at least one CORESET.

Aspect 8 is the method of any of aspects 1 to 6, wherein the first precoder granularity is associated with a first symbol index of the first CORESET symbol and the second precoder granularity is associated with a second symbol index of the second CORESET symbol.

Aspect 9 is the method of any of aspects 1 to 7, wherein the DM-RS is non-transparent, and wherein decoding or refraining from decoding the first CORESET symbol and the second CORESET symbol includes decoding the first CORESET symbol and the second CORESET symbol, further comprising: estimating a joint channel across the first CORESET symbol and the second CORESET symbol based on the DM-RS being non-transparent.

Aspect 10 is the method of aspect 9, wherein the first precoder granularity is associated with a codebook-based precoder cycle associated with resource element (RE) groups (REGs) on the first CORESET symbol, wherein the second precoder granularity is associated with a common wideband (WB) precoder for the second CORESET symbol.

Aspect 11 is the method of aspect 10, wherein a step size of the codebook-based precoder cycle is equal to the first precoder granularity associated with the first CORESET symbol.

Aspect 12 is the method of any of aspects 1 to 6 and 8 to 11, wherein the first CORESET symbol and the second CORESET symbol are of different CORESETs of the at least one CORESET, wherein the different CORESETs include a first CORESET and a second CORESET, wherein the first CORESET symbol and the second CORESET symbol include a search space mapping to a same search space set.

Aspect 13 is the method of aspect 12, wherein the PDCCH candidate is a single PDCCH that is associated with each CORESET of the at least one CORESET; wherein the first CORESET is configured with a higher DM-RS density than other CORESETs of the at least one CORESET; or wherein the first CORESET is configured at a beginning of the at least one CORESET.

Aspect 14 is the method of aspect 13, wherein the first precoder granularity that is different than a wideband (WB) precoder granularity and that is associated with the first CORESET is equal to a first number of resource element (RE) groups (REGs) in a frequency domain for a narrow band REG bundle within a control channel element (CCE) associated with the first CORESET; or wherein a CCE-to-REG mapping is non-interleaved and the first precoder granularity associated with the first CORESET is associated with a second number of REGs in each CCE, an aggregation level, and a third number of CORESET symbols in the first CORESET.

Aspect 15 is the method of any of aspects 1 to 14, wherein identifying the presence or the absence of the PDCCH candidate in the at least one CORESET includes identifying the absence of the PDCCH candidate based on the associated absence of the DM-RS for the first CORESET; wherein refraining from decoding the first CORESET symbol and the second CORESET symbol includes skipping decoding attempts associated with the PDCCH candidate across the at least one CORESET.

Aspect 16 is a method of wireless communication at a network node, comprising: configuring a user equipment (UE) with a precoder granularity configuration indicative of a set of precoder granularities for at least one control resource set (CORESET), wherein the set of precoder granularities includes a first precoder granularity associated with a first CORESET symbol of the at least one CORESET and a second precoder granularity associated with a second CORESET symbol of the at least one CORESET, wherein the second precoder granularity is different than the first precoder granularity; and transmitting, for the UE, the at least one CORESET that includes the first precoder granularity associated with the first CORESET symbol and the second precoder granularity associated with the second CORESET symbol.

Aspect 17 is the method of aspect 16, wherein the first precoder granularity associated with the first CORESET symbol is equal to a first number of resource element (RE) groups (REGs) in a frequency domain for a narrow band REG bundle within a control channel element (CCE) associated with the at least one CORESET.

Aspect 18 is the method of any of aspects 16 and 17, wherein a CCE-to-REG mapping is non-interleaved and the first precoder granularity associated with the first CORESET symbol is associated with a second number of REGs in each CCE, an aggregation level, and a third number of CORESET symbols in the at least one CORESET.

Aspect 19 is the method of any of aspects 16 to 18, wherein the second precoder granularity is a wideband (WB) precoder granularity and the first precoder granularity is a smaller precoder granularity than the WB precoder granularity.

Aspect 20 is the method of any of aspects 16 to 19, wherein the first CORESET symbol includes a one-to-one mapping between a demodulation reference signal (DM-RS) for the first CORESET symbol and a physical downlink control channel (PDCCH) candidate for the first CORESET symbol.

Aspect 21 is the method of any of aspects 16 to 20, wherein the first CORESET symbol and the second CORESET symbol are of a same CORESET of the at least one CORESET; or wherein the first precoder granularity is associated with a first symbol index of the first CORESET symbol and the second precoder granularity is associated with a second symbol index of the second CORESET symbol.

Aspect 22 is the method of any of aspects 16 to 21, wherein a demodulation reference signal (DM-RS) for the first CORESET symbol is non-transparent, and wherein transmitting the first CORESET symbol includes: transmitting the DM-RS for an estimation of a joint channel across the first CORESET symbol and the second CORESET symbol based on the DM-RS being non-transparent.

Aspect 23 is the method of aspect 22, wherein the first precoder granularity is associated with a codebook-based precoder cycle associated with resource element (RE) groups (REGs) on the first CORESET symbol, wherein the second precoder granularity is associated with a common wideband (WB) precoder for the second CORESET symbol.

Aspect 24 is the method of aspect 23, wherein a step size of the codebook-based precoder cycle is equal to the first precoder granularity associated with the first CORESET symbol.

Aspect 25 is the method of any of aspects 16 to 20 and 22 to 24, wherein the first CORESET symbol and the second CORESET symbol are of different CORESETs of the at least one CORESET, wherein the different CORESETs include a first CORESET and a second CORESET, wherein the first CORESET symbol and the second CORESET symbol include a search space mapping to a same search space set.

Aspect 26 is the method of aspect 25, wherein a physical downlink control channel (PDCCH) candidate associated with the at least one CORESET is a single PDCCH that is associated with each CORESET of the at least one CORESET; wherein the first CORESET is configured with a higher DM-RS density than other CORESETs of the at least one CORESET; or wherein the first CORESET is configured at a beginning of the at least one CORESET.

Aspect 27 is the method of aspect 26, wherein the first precoder granularity that is different than a wideband (WD) precoder granularity and that is associated with the first CORESET is equal to a first number of resource element (RE) groups (REGs) in a frequency domain for a narrow band REG bundle within a control channel element (CCE) associated with the first CORESET.

Aspect 28 is the method of any of aspects 26 and 27, wherein a CCE-to-REG mapping is non-interleaved and the first precoder granularity associated with the first CORESET is associated with a second number of REGs in each CCE, an aggregation level, and a third number of CORESET symbols in the first CORESET.

Aspect 29 is an apparatus for wireless communication at a user equipment (UE), comprising: at least one memory; and at least one processor coupled to the at least one memory, the at least one processor, individually or in any combination, is configured to perform the method of any of aspects 1 to 15.

Aspect 30 is an apparatus for wireless communication at a user equipment (UE), comprising means for performing each step in the method of any of aspects 1 to 15.

Aspect 31 is the apparatus of any of aspects 29 to 30, further comprising a transceiver configured to receive or to transmit in association with the method of any of aspects 1 to 15.

Aspect 32 is a computer-readable medium (e.g., a non-transitory computer-readable medium) storing computer executable code at a user equipment (UE), the code when executed by at least one processor causes the at least one processor to perform the method of any of aspects 1 to 15.

Aspect 33 is an apparatus for wireless communication at a network node, comprising: at least one memory; and at least one processor coupled to the at least one memory, the at least one processor, individually or in any combination, is configured to perform the method of any of aspects 16 to 28.

Aspect 34 is an apparatus for wireless communication at a network node, comprising means for performing each step in the method of any of aspects 16 to 28.

Aspect 35 is the apparatus of any of aspects 33 to 34, further comprising a transceiver configured to receive or to transmit in association with the method of any of aspects 16 to 28.

Aspect 36 is a computer-readable medium (e.g., a non-transitory computer-readable medium) storing computer executable code at a network node, the code when executed by at least one processor causes the at least one processor to perform the method of any of aspects 16 to 28.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, at least one control resource set (CORESET) that includes a first precoder granularity associated with a first CORESET symbol and a second precoder granularity associated with a second CORESET symbol, wherein the second precoder granularity is different than the first precoder granularity;
identify a presence or an absence of a physical downlink control channel (PDCCH) candidate in the at least one CORESET based on an associated presence or an associated absence of a demodulation reference signal (DM-RS) for the first CORESET symbol; and
decode or refrain from decoding the first CORESET symbol and the second CORESET symbol based on the presence or the absence of the PDCCH candidate in the at least one CORESET.

2. The apparatus of claim 1, further comprising at least one transceiver coupled to the at least one processor, wherein the at least one processor, individually or in any combination, is further configured to:
receive, from the network node and via the at least one transceiver, a precoder granularity configuration indicative of a set of precoder granularities, wherein the set of precoder granularities includes the first precoder granularity and the second precoder granularity.

3. The apparatus of claim 1, wherein to identify the presence or the absence of the PDCCH candidate in the at least one CORESET, the at least one processor, individually or in any combination, is configured to identify the absence of the PDCCH candidate based on the associated absence of the DM-RS for the first CORESET symbol;
wherein to refrain from decoding the first CORESET symbol and the second CORESET symbol, the at least one processor, individually or in any combination, is configured to skip decoding attempts associated with the PDCCH candidate.

4. The apparatus of claim 3, wherein the first precoder granularity associated with the first CORESET symbol is equal to a first number of resource element (RE) groups (REGs) in a frequency domain for a narrow band REG bundle within a control channel element (CCE) associated with the at least one CORESET; or
wherein a CCE-to-REG mapping is non-interleaved and the first precoder granularity associated with the first CORESET symbol is associated with a second number of REGs in each CCE, an aggregation level, and a third number of CORESET symbols in the at least one CORESET.

5. The apparatus of claim 3, wherein the second precoder granularity is a wideband (WB) precoder granularity and the first precoder granularity is a smaller precoder granularity than the WB precoder granularity.

6. The apparatus of claim 1, wherein the first CORESET symbol includes a one-to-one mapping between the DM-RS and the PDCCH candidate.

7. The apparatus of claim 1, wherein the first CORESET symbol and the second CORESET symbol are of a same CORESET of the at least one CORESET.

8. The apparatus of claim 1, wherein the first precoder granularity is associated with a first symbol index of the first CORESET symbol and the second precoder granularity is associated with a second symbol index of the second CORESET symbol.

9. The apparatus of claim 1, wherein the DM-RS is non-transparent, and wherein decoding or refraining from decoding the first CORESET symbol and the second CORESET symbol includes decoding the first CORESET symbol and the second CORESET symbol, wherein the at least one processor, individually or in any combination, is further configured to:
estimate a joint channel across the first CORESET symbol and the second CORESET symbol based on the DM-RS being non-transparent.

10. The apparatus of claim 9, wherein the first precoder granularity is associated with a codebook-based precoder cycle associated with resource element (RE) groups (REGs) on the first CORESET symbol, wherein the second precoder granularity is associated with a common wideband (WB) precoder for the second CORESET symbol.

11. The apparatus of claim 10, wherein a step size of the codebook-based precoder cycle is equal to the first precoder granularity associated with the first CORESET symbol.

12. The apparatus of claim 1, wherein the first CORESET symbol and the second CORESET symbol are of different CORESETs of the at least one CORESET, wherein the different CORESETs include a first CORESET and a second CORESET, wherein the first CORESET symbol and the second CORESET symbol include a search space mapping to a same search space set.

13. The apparatus of claim 12, wherein the PDCCH candidate is a single PDCCH that is associated with each CORESET of the at least one CORESET;
wherein the first CORESET is configured with a higher DM-RS density than other CORESETs of the at least one CORESET; or
wherein the first CORESET is configured at a beginning of the at least one CORESET.

14. The apparatus of claim 13, wherein the first precoder granularity that is different than a wideband (WB) precoder granularity and that is associated with the first CORESET is equal to a first number of resource element (RE) groups (REGs) in a frequency domain for a narrow band REG bundle within a control channel element (CCE) associated with the first CORESET; or
wherein a CCE-to-REG mapping is non-interleaved and the first precoder granularity associated with the first CORESET is associated with a second number of REGs in each CCE, an aggregation level, and a third number of CORESET symbols in the first CORESET.

15. The apparatus of claim 1, wherein to identify the presence or the absence of the PDCCH candidate in the at least one CORESET, the at least one processor, individually or in any combination, is configured to identify the absence of the PDCCH candidate based on the associated absence of the DM-RS for the first CORESET;
wherein to refrain from decoding the first CORESET symbol and the second CORESET symbol, the at least one processor, individually or in any combination, is configured to skip decoding attempts associated with the PDCCH candidate across the at least one CORESET.

16. An apparatus for wireless communication at a network node, comprising:
at least one memory; and
at least one processor coupled to the at least one memory and, based at least in part on information stored in the at least one memory, the at least one processor, individually or in any combination, is configured to:
configure a user equipment (UE) with a precoder granularity configuration indicative of a set of precoder granularities for at least one control resource set (CORESET), wherein the set of precoder granularities includes a first precoder granularity associated with a first CORESET symbol of the at least one CORESET and a second precoder granularity associated with a second CORESET symbol of the at least one CORESET, wherein the second precoder granularity is different than the first precoder granularity; and
transmit, for the UE, the at least one CORESET that includes the first precoder granularity associated with the first CORESET symbol and the second precoder granularity associated with the second CORESET symbol.

17. The apparatus of claim 16, wherein the first precoder granularity associated with the first CORESET symbol is equal to a first number of resource element (RE) groups (REGs) in a frequency domain for a narrow band REG bundle within a control channel element (CCE) associated with the at least one CORESET.

18. The apparatus of claim 16, wherein a CCE-to-REG mapping is non-interleaved and the first precoder granularity associated with the first CORESET symbol is associated with a second number of REGs in each CCE, an aggregation level, and a third number of CORESET symbols in the at least one CORESET.

19. The apparatus of claim 16, wherein the second precoder granularity is a wideband (WB) precoder granularity and the first precoder granularity is a smaller precoder granularity than the WB precoder granularity.

20. The apparatus of claim 16, wherein the first CORESET symbol includes a one-to-one mapping between a demodulation reference signal (DM-RS) for the first CORESET symbol and a physical downlink control channel (PDCCH) candidate for the first CORESET symbol.

21. The apparatus of claim 16, wherein the first CORESET symbol and the second CORESET symbol are of a same CORESET of the at least one CORESET; or
wherein the first precoder granularity is associated with a first symbol index of the first CORESET symbol and the second precoder granularity is associated with a second symbol index of the second CORESET symbol.

22. The apparatus of claim 16, further comprising at least one transceiver coupled to the at least one processor, wherein a demodulation reference signal (DM-RS) for the first CORESET symbol is non-transparent, and wherein to transmit the first CORESET symbol, the at least one processor, individually or in any combination, is configured to:
transmit, via the at least one transceiver, the DM-RS for an estimation of a joint channel across the first CORESET symbol and the second CORESET symbol based on the DM-RS being non-transparent.

23. The apparatus of claim 22, wherein the first precoder granularity is associated with a codebook-based precoder cycle associated with resource element (RE) groups (REGs) on the first CORESET symbol, wherein the second precoder granularity is associated with a common wideband (WB) precoder for the second CORESET symbol.

24. The apparatus of claim 23, wherein a step size of the codebook-based precoder cycle is equal to the first precoder granularity associated with the first CORESET symbol.

25. The apparatus of claim 16, wherein the first CORESET symbol and the second CORESET symbol are of different CORESETs of the at least one CORESET, wherein the different CORESETs include a first CORESET and a second CORESET, wherein the first CORESET symbol and the second CORESET symbol include a search space mapping to a same search space set.

26. The apparatus of claim 25, wherein a physical downlink control channel (PDCCH) candidate associated with the at least one CORESET is a single PDCCH that is associated with each CORESET of the at least one CORESET;
wherein the first CORESET is configured with a higher DM-RS density than other CORESETs of the at least one CORESET; or
wherein the first CORESET is configured at a beginning of the at least one CORESET.

27. The apparatus of claim 26, wherein the first precoder granularity that is different than a wideband (WB) precoder granularity and that is associated with the first CORESET is equal to a first number of resource element (RE) groups (REGs) in a frequency domain for a narrow band REG bundle within a control channel element (CCE) associated with the first CORESET.

28. The apparatus of claim 26, wherein a CCE-to-REG mapping is non-interleaved and the first precoder granularity associated with the first CORESET is associated with a second number of REGs in each CCE, an aggregation level, and a third number of CORESET symbols in the first CORESET.

29. A method of wireless communication at a user equipment (UE), comprising:
receiving, from a network node, at least one control resource set (CORESET) that includes a first precoder granularity associated with a first CORESET symbol and a second precoder granularity associated with a second CORESET symbol, wherein the second precoder granularity is different than the first precoder granularity;
identifying a presence or an absence of a physical downlink control channel (PDCCH) candidate in the at least one CORESET based on an associated presence or an associated absence of a demodulation reference signal (DM-RS) for the first CORESET symbol; and
decoding or refraining from decoding the first CORESET symbol and the second CORESET symbol based on the presence or the absence of the PDCCH candidate in the at least one CORESET.

30. A method of wireless communication at a network node, comprising:
configuring a user equipment (UE) with a precoder granularity configuration indicative of a set of precoder granularities for at least one control resource set (CORESET), wherein the set of precoder granularities includes a first precoder granularity associated with a first CORESET symbol of the at least one CORESET and a second precoder granularity associated with a second CORESET symbol of the at least one CORESET, wherein the second precoder granularity is different than the first precoder granularity; and
transmitting, for the UE, the at least one CORESET that includes the first precoder granularity associated with the first CORESET symbol and the second precoder granularity associated with the second CORESET symbol.
